(19) United States
(12) Patent Application Publication
(10) Pub. No.: US 2014/0000437 A1
(43) Pub. Date: Jan. 2, 2014

(54) KEYBOARD DEVICE FOR ELECTRONIC MUSICAL INSTRUMENT

(71) Applicant: YAMAHA CORPORATION, Hamamatsu-shi (JP)

(72) Inventors: Ichiro OSUGA, Hamamatsu-shi (JP); Kenichi NISHIDA, Hamamatsu-shi (JP); Shunsuke ICHIKI, Hamamatsu-shi (JP); Hiroshi HARIMOTO, Hamamatsu-shi (JP); Shin YAMAMOTO, Hamamatsu-shi (JP)

(21) Appl. No.: 13/927,169

(22) Filed: Jun. 26, 2013

(30) Foreign Application Priority Data
Jul. 2, 2012 (JP) 2012-148155
Jul. 2, 2012 (JP) 2012-148156
Aug. 31, 2012 (JP) 2012-190796

(51) Int. Cl. G10H 1/34

(52) U.S. Cl. CPC G10H 1/34
USPC 84/423 R

(57) ABSTRACT

A keyboard device includes plural white keys, plural black keys, and plural hammers respectively engaged with the plural white and black keys. Vertical length of a drive portion for a first key and a second key are set the same, the first and second keys both being white keys, or both being black keys. Longitudinal position of hammer support portion of a first hammer engaged with the first key and longitudinal position of a hammer support portion of a second hammer engaged with the second key are set the same. Vertical positions of hammer support portions of the first and second hammers are respectively set according to a distance from a front end of an operation portion of the first key and a key support portion and a distance from a front end of an operation portion of the second key and a key support portion.

### BACKGROUND OF THE INVENTION

1. Field of the Invention

The present invention relates to a keyboard device for an electronic musical instrument such as an electronic organ, an electronic piano, and the like.

2. Description of the Related Art

There has conventionally been known a keyboard device for an electronic musical instrument described in Japanese Patent No. 3074794. In this keyboard device described above, a key touch feeling (reaction force against a key depression/release operation) on a front end of a key, to which a higher pitch is assigned, is set lighter in order to generate a key touch feeling similar to a key touch feeling of an acoustic piano. This keyboard device has plural hammers, each of which rocks through an engagement with the corresponding key so as to apply reaction force against the depression/release operation of the corresponding key. The plural hammers are common components. In this keyboard device, the length from the pivot point of the key, formed on a back end, to the front end of the key becomes gradually longer toward the keys on the high-pitched side from the keys on the low-pitched side. In addition, the position of the pivot point of each hammer is gradually shifted backward from the low-pitched side toward the high-pitched side, by which the distance from the pivot point of the key to the engagement position between the hammer and the key is set to be the same for all keys.

The conventional keyboard device described above has an upper-limit stopper for restricting the upward displacement of the key, the upper-limit stopper being provided posterior to the front end of the key (the end close to a performer). An engagement portion extending downward from the lower surface of the key is brought into contact with the upper-limit stopper. The key tilts such that the back end of the key becomes lower than the front end of the key during the key release state. Therefore, if the length of the engagement portion in the vertical direction is the same for plural keys, the height of the portion, which is just above the contact point of the upper-limit stopper on the top surface of each of the plural keys, becomes the same during the key release state. The shorter the key is, the larger the tilt angle of the key during the key release state becomes. Therefore, the position of the front end of the shorter key out of the plural keys is higher. As described above, the appearance is not considered in the conventional keyboard device.

The conventional keyboard device described above also has a lower-limit stopper for restricting the downward displacement of the key, the lower-limit stopper being provided posterior to the front end of the key. The lower surface of the engagement portion is brought into contact with the lower-limit stopper. Therefore, the rocking range of the front end of the shorter key, out of the plural keys, is larger. A hammer is engaged with the corresponding key at a portion posterior to the engagement portion. The pivot point of the hammer of the shorter key is closer to the engagement portion. Therefore, the contact position of the hammer with the shorter key in the key release state is higher. Accordingly, the rocking range of the hammer, engaged with the shorter key, with the key is larger. In the conventional keyboard device described above, the hammer can rock apart from the hammer. However, as described above, since the rocking range of the hammer with the rocking movement of the key is different depending upon the key with which the hammer is to be engaged, the timing of detaching the hammer from the key (or the depth of the key depression) is different according to the length of the key. The difference in the timing of detaching the hammer from the key is considered to give influence to the key touch feeling. However, the conventional keyboard device does not consider this point.

The present invention is accomplished to solve the problem involved with the appearance of the keyboard device, out of the problems of the conventional keyboard device. Specifically, the present invention aims to provide a keyboard device for an electronic musical instrument having an appearance similar to an appearance of a keyboard device for an acoustic piano. For easy understanding of the present invention, a numeral of a corresponding portion in an embodiment is written in a parenthesis in the description below of each constituent of the present invention. However, each constituent of the present invention should not be construed as being limited to the corresponding portion indicated by the numeral in the embodiment.

In order to attain the foregoing object, the present invention provides a keyboard device for an electronic musical instrument, the keyboard device including: plural white keys and black keys (111w, 111b) that are supported by a key support portion (Kw1, 113w1, Kb1, 113b1) in order that front ends thereof rock in a vertical direction by a key depression/release operation by a performer, each white key having an edge line extending in a longitudinal direction on a crossing portion of a side face and a top face, and each black key having an edge line extending in the longitudinal direction on a crossing portion of a lower side face and an upper side face tilting inward with respect to the lower side face, wherein each of plural white keys and each of black keys include an operation portion that is depressed and released by the performer, and a drive portion (111w1, 111b1) extending downward, and a length from the front end of the operation portion to the key support portion is different among the plural white keys and black keys; plural hammers (116w, 116b), each of which is engaged with the drive portion of each of the plural white keys and the drive portion of each of the plural black keys, and each of which is supported by a hammer support portion (Hw1, 118w1, Hb1, 118b1) in order to rock with the rocking movement of each of the plural white keys and black keys; and a restricting member (120, 121) that restricts the rocking movement of the plural hammers in order to restrict the rocking range of the plural white keys and the plural black keys, wherein a vertical length of the drive portion of a first key and a vertical length of the drive portion of a second key are set to be the same, the first key and the second key being both the white keys or both the black keys out of the plural white keys and the plural black keys, and the vertical position of the hammer support portion of the first hammer engaged with the first key and the vertical position of the hammer support portion of the second hammer engaged with the second key are respectively set to a position according to the distance from the front end of the operation portion of the first key to the key support portion and the distance from the front end of the operation portion of the second key to the key support portion, in order that the vertical positions of the front ends of the operation portions of the first key and the second key become the same in a state in which the first key and the second key are released. In a state in which stopping force of stopping the hammer by the restricting member is transmitted through the engagement portion between the key and the hammer, it is regarded that the rocking movement of the key is substantially restricted by the restricting member of the hammer. The state in which the key is released means the state where the upward displacement of the front end of the operation portion of the key is restricted.

In this case, it is preferable that the drive portion of the first key and the drive portion of the second key are respectively provided posterior to the front end of the operation portion of the first key and the front end of the operation of the second key, the distance from the front end of the operation portion of the first key to the key support portion is longer than the distance from the front end of the operation portion of the second key to the key support portion, and the hammer support portion of the first hammer is located to be higher than the hammer support portion of the second hammer.

In this case, it is preferable that the drive portion of the first key and the drive portion of the second key are respectively provided anterior to the front end of the operation portion of the first key and the front end of the operation of the second key, the distance from the front end of the operation portion of the first key to the key support portion is longer than the distance from the front end of the operation portion of the second key to the key support portion, and the hammer support portion of the first hammer is located to be lower than the hammer support portion of the second hammer.

In this case, it is preferable that the length from the front end of the operation portion to the back end of the plural white keys becomes shorter toward the high-pitched side from the low-pitched side, and the length from the front end of the operation portion to the back end of the plural black keys becomes shorter toward the high-pitched side from the low-pitched side.

In this case, it is preferable that the first key and the second key are adjacent white keys, and the edge line of the black key between the first key and the second key is located between the top face of the first key and the top face of the second key, in a state in which the first key, the second key, and the black key are released.

In this case, it is preferable that the first key and the second key are adjacent white keys, and the edge line of the black key between the first key and the second key is located below the top face of the first key and the top face of the second key, in a state in which the first key, the second key, and the black key are depressed, and the rocking movements of the first key, the second key, and the black key are restricted. The state in which the rocking movement is restricted means the state where the same load is applied to the front end of the white key and to the front end of the black key, and the rocking movement of the key is restricted, for example. The present invention also includes the case where a part of the edge line of the black key on the front end is located below the top face of the first key and the top face of the second key.

According to the present invention, the vertical position of the hammer support portion is set according to the length of the key. With this structure, the vertical position of the engagement point where the key and the hammer are engaged with each other in the key release state is made different, whereby the height of the front end of the first key and the height of the front end of the second key in the key release state can be adjusted to be the same. Accordingly, the keyboard device according to the present invention has an appearance similar to an appearance of an acoustic piano in the key release state.

Another aspect of the present invention is a keyboard device for an electronic musical instrument, the keyboard device including: plural white keys and black keys (211w, 211b) that are supported by a key support portion (Kw2, 213w1, Kb2, 213b1) in order that front ends thereof rock in a vertical direction by a key depression/release operation by a performer, each white key having an edge line extending in a longitudinal direction on a crossing portion of a side face and a top face, and each black key having an edge line extending in the longitudinal direction on a crossing portion of a lower side face and an upper side face tilting inward with respect to the lower side face, wherein each of plural white keys and each of black keys include an operation portion that is depressed and released by the performer, and a drive portion (211w1, 211b1) extending downward, and a length from the front end of the operation portion to the key support portion is different among the plural white keys and black keys; plural hammers (216w, 216b), each of which includes an engagement portion engaged with the drive portion of each of the plural white keys and the drive portion of each of the plural black keys, and each of which is supported by a hammer support portion (Hw2, 218w1, Hb2, 218b1) in order to rock with the rocking movement of each of the plural white keys and black keys; and a restricting member (220, 221, 221A) that restricts the rocking movement of the plural hammers in order to restrict the rocking range of the plural white keys and the plural black keys, wherein a vertical length of the drive portion of a first key and a vertical length of the drive portion of a second key are set to be the same, the first key and the second key being both the white keys or being both the black keys out of the plural white keys and the plural black keys, the longitudinal position and the vertical position of the hammer support portion of the first hammer engaged with the first key and the longitudinal position and the vertical position of the hammer support portion of the second hammer engaged with the second key are set to be the same, and a vertical position of an engagement point of the first key and the first hammer and a vertical position of an engagement point of the second key and the second hammer are respectively set to a position according to the distance from the front end of the operation portion of the first key to the key support portion and the distance from the front end of the operation portion of the second key to the key support portion, in order that the vertical positions of the front ends of the operation portions of the first key and the second key become the same in a state in which the first key and the second key are released. In a state in which stopping force of stopping the hammer by the restricting member is transmitted through the engagement portion between the key and the hammer, it is regarded that the rocking movement of the key is substantially restricted by the restricting member of the hammer. The state in which the key is released means the state where the upward displacement of the front end of the operation portion of the key is restricted.

In this case, it is preferable that the restricting member includes an upper-limit stopper (221, 221A) restricting an upward rocking movement of the front ends of the first key and the second key, and a position of a contact point between the first hammer and the upper-limit stopper and a position of a contact point between the second hammer and the upper-limit stopper are respectively set to a position according to the distance from the front end of the operation portion of the first key to the key support portion and the distance from the front end of the operation portion of the second key to the key support portion, in order that a rocking angle of the first hammer and a rocking angle of the second hammer in the key release state of the first key and the second key are respectively set to an angle according to the distance from the front end of the operation portion of the first key to the key support portion and the distance from the front end of the operation portion of the second key to the key support portion.

In this case, it is preferable that the first hammer and the second hammer respectively include a contact portion (216w3, 216b3) to the upper-limit stopper, the contact portion has a contact surface extending in the longitudinal direction, the contact surface tilts with respect to a mounting surface (FR2) of the upper-limit stopper in the key release state of the first key and the second key, and the longitudinal position of the upper-limit stopper with respect to the contact portion of the first hammer and the longitudinal position of the upper-limit stopper with respect to the contact portion of the second hammer are respectively set to a position according to the distance from the front end of the operation portion of the first key to the key support portion and the distance from the front end of the operation portion of the second key to the key support portion, in order that the vertical position of the contact point between the first hammer and the upper-limit stopper and the vertical position of the contact point between the second hammer and the upper-limit stopper are set to be the same, and that the longitudinal position of the contact point between the first hammer and the upper-limit stopper and the longitudinal position of the contact point between the second hammer and the upper-limit stopper are respectively set to a position according to the distance from the front end of the operation portion of the first key to the key support portion and the distance from the front end of the operation portion of the second key to the key support portion.

In this case, it is preferable that the drive portion of each of the plural white keys is provided posterior to the front end of the operation portion of each of the plural white keys, the drive portion of each of the plural black keys is provided anterior to the front end of the operation portion of each of the plural black keys, and a tilting direction of the contact surface of the hammer engaged with the white key and a tilting direction of the contact surface of the hammer engaged with the black key are reverse to each other.

In this case, it is preferable that the thickness of the upper-limit stopper (221A) that is in contact with the first hammer and the second hammer is set to be a thickness according to the distance from the front end of the operation portion of the first key to the key support portion and the distance from the front end of the operation portion of the second key to the key support portion, in order that the vertical position of the contact point between the first hammer and the upper-limit stopper and the vertical position of the contact point between the second hammer and the upper-limit stopper are respectively set to a position according to the distance from the front end of the operation portion of the first key to the key support portion and the distance from the front end of the operation portion of the second key to the key support portion.

In this case, it is preferable that the engagement portion of the first hammer and the engagement portion of the second hammer respectively have a base member (Fw21, Fw22, Fb21, Fb22) and a spacer (SP) mounted to the base member, and the thickness of the spacer is set according to the distance from the front end of the operation portion of the first key to the key support portion and the distance from the front end of the operation portion of the second key to the key support portion.

In this case, it is preferable that the first hammer and the second hammer are bent in the vertical direction on the middle part in the longitudinal direction by a bending process, and a bending amount of the first hammer and the second hammer by the bending process is set according to the distance from the front end of the operation portion of the first key to the key support portion and the distance from the front end of the operation portion of the second key to the key support portion.

In this case, it is preferable that the length from the front end of the operation portion to the back end of the plural white keys becomes shorter toward the high-pitched side from the low-pitched side, and the length from the front end of the operation portion to the back end of the plural black keys becomes shorter toward the high-pitched side from the low-pitched side.

In this case, it is preferable that the first key and the second key are adjacent white keys, and the edge line of the black key between the first key and the second key is located between the top face of the first key and the top face of the second key, in a state in which the first key, the second key, and the black key are released.

In this case, it is preferable that the first key and the second key are adjacent white keys, and the edge line of the black key between the first key and the second key is located below the top face of the first key and the top face of the second key, in a state in which the first key, the second key, and the black key are depressed, and the rocking movements of the first key, the second key, and the black key are restricted. The state in which the rocking movement is restricted means the state where the same load is applied to the front end of the white key and to the front end of the black key, and the rocking movement of the key is restricted, for example. The present invention also includes the case where a part of the edge line of the black key on the front end is located below the top face of the first key and the top face of the second key.

According to the present invention, the vertical position of the engagement point where the key and the hammer are engaged with each other in the key release state is made different by the structure in which the rocking angle of the hammer in the key release state is made different, the thickness of the spacer mounted to the base member is made different, and the bending amount of the hammer in the bending process is made different, whereby the height of the front end of the first key and the height of the front end of the second key in the key release state can be adjusted to be the same. Accordingly, the keyboard device according to the present invention has an appearance similar to an appearance of an acoustic piano in the key release state.

Another aspect of the present invention is a keyboard device for an electronic musical instrument, the keyboard device including: plural white keys and black keys (311w, 311b) that are supported by a key support portion (Kw3, 313w1, Kb3, 313b1) in order that front ends thereof rock in a vertical direction by a key depression/release operation by a performer, each white key having an edge line extending in a longitudinal direction on a crossing portion of a side face and a top face, and each black key having an edge line extending in the longitudinal direction on a crossing portion of a lower side face and an upper side face tilting inward with respect to the lower side face, wherein each of plural white keys and each of black keys include an operation portion that is depressed and released by the performer, and a drive portion (311w1, 311b1) extending downward, and a length from the front end of the operation portion to the key support portion is different among the plural white keys and black keys; plural hammers (316w, 316b), each of which is engaged with the drive portion of each of the plural white keys and the drive portion of each of the plural black keys, and each of which is supported by a hammer support portion (Hw3, 318w1, Hb3, 318b1) in order to rock with the rocking movement of each of the plural white keys and black keys; and a restricting member (320, 321) that restricts the rocking movement of the plural hammers in order to restrict the rocking range of the plural white keys and the plural black keys, wherein vertical positions of engagement portions between the plural white keys as well as the plural black keys and the plural hammers are set to be the same in a state in which the plural white keys and the plural black keys are released, and in a state in which a first key and a second key out of the plural white keys and the plural black keys are released, the first key and the second key being both the white keys or being both the black keys, the vertical size of the first key and the vertical size of the second key are respectively set according to the distance from the front end of the operation portion of the first key to the key support portion and the distance from the front end of the operation portion of the second key to the key support portion in order that the vertical positions of the front ends of the operation portions of the first key and the second key become the same. In a state in which stopping force of stopping the hammer by the restricting member is transmitted through the engagement portion between the key and the hammer, it is regarded that the rocking movement of the key is substantially restricted by the restricting member of the hammer. The state in which the key is released means the state where the upward displacement of the front end of the operation portion of the key is restricted.

In this case, it is preferable that the first key and the second key are configured by combining plural components (Uw, Mw, Lw, Ub, Mb, Lb) in the vertical direction, and the vertical size of one or more components out of the plural components forming the first key and the second key is set according to the distance from the front end of the operation portion of the first key to the key support portion and the distance from the front end of the operation portion of the second key to the key support portion.

In this case, it is preferable that the plural components forming the first key and the second key include a shock absorbing member (SA) mounted on a lower end of the drive portion, and the thickness of the shock absorbing member is set according to the distance from the front end of the operation portion of the first key to the key support portion and the distance from the front end of the operation portion of the second key to the key support portion.

In this case, it is preferable that the length from the front end of the operation portion to the back end of the plural white keys becomes shorter toward the high-pitched side from the low-pitched side, and the length from the front end of the operation portion to the back end of the plural black keys becomes shorter toward the high-pitched side from the low-pitched side.

In this case, it is preferable that the first key and the second key are adjacent white keys, and the edge line of the black key between the first key and the second key is located between the top face of the first key and the top face of the second key, in a state in which the first key, the second key, and the black key are released.

In this case, it is preferable that the first key and the second key are adjacent white keys, and the edge line of the black key between the first key and the second key is located below the top face of the first key and the top face of the second key, in a state in which the first key, the second key, and the black key are depressed, and the rocking movements of the first key, the second key, and the black key are restricted. The state in which the rocking movement is restricted means the state where the same load is applied to the front end of the white key and to the front end of the black key, and the rocking movement of the key is restricted, for example. The present invention also includes the case where a part of the edge line of the black key on the front end is located below the top face of the first key and the top face of the second key.

According to the present invention, the vertical size of the first key and the vertical size of the second key are set according to the longitudinal length of the first key and the longitudinal length of the second key in order that the height of the front end of the first key and the height of the front end of the second key in the key release state are adjusted to be the same. Accordingly, the keyboard device according to the present invention has an appearance similar to an appearance of an acoustic piano in the key release state.

Still another aspect of the present invention is that the distance between a plane including the edge line of the first key and the key support portion of the first key is set to be the same as the distance between a plane including the edge line of the second key and the key support portion of the second key. In this case, it is preferable that the vertical positions of the key support portions of the first key and the second key are set to be the same. With this structure, the parts other than the parts involved with the length of the key can be made common as much as possible. This structure also simplifies the design of the support member (frame) supporting the key. This structure also facilitates the processing of the support member, whereby precision can be enhanced.

### BRIEF DESCRIPTION OF THE DRAWINGS

Various other objects, features and many of the attendant advantages of the present invention will be readily appreciated as the same becomes better understood by reference to the following detailed description of the preferred embodiment when considered in connection with the accompanying drawings, in which:

FIG. 1 is a plan view illustrating a keyboard device according to a first embodiment of the present invention;

FIG. 2 is a right side view illustrating a configuration of a white key on a low-pitched side in the keyboard device illustrated in FIG. 1;

FIG. 3 is a right side view illustrating a configuration of a white key on a high-pitched side in the keyboard device illustrated in FIG. 1;

FIG. 4 is a right side view illustrating a configuration of a black key on a low-pitched side in the keyboard device illustrated in FIG. 1;

FIG. 5 is a right side view illustrating a configuration of a black key on a high-pitched side in the keyboard device illustrated in FIG. 1;

FIG. 6 is a graph of a characteristic curve illustrating a relationship between a pitch and a mass of a mass member;

FIG. 7 is a graph of a characteristic curve illustrating a relationship between a pitch and a key touch;

FIG. 8 is a schematic view illustrating a difference in the configuration between the white key on the low-pitched side and the white key on the high-pitched side in FIG. 1;

FIG. 9 is a schematic view illustrating a difference in the configuration between the black key on the low-pitched side and the black key on the high-pitched side in FIG. 1;

FIG. 10 is a plan view illustrating a keyboard device according to a second embodiment of the present invention;

FIG. 11 is a right side view illustrating a configuration of a white key on a low-pitched side in the keyboard device illustrated in FIG. 10;

FIG. 12 is a right side view illustrating a configuration of a white key on a high-pitched side in the keyboard device illustrated in FIG. 10;

FIG. 13 is a right side view illustrating a configuration of a black key on a low-pitched side in the keyboard device illustrated in FIG. 10;

FIG. 14 is a right side view illustrating a configuration of a black key on a high-pitched side in the keyboard device illustrated in FIG. 10;

FIG. 15 is a graph of a characteristic curve illustrating a relationship between a pitch and a mass of a mass member;

FIG. 16 is a graph of a characteristic curve illustrating a relationship between a pitch and a key touch;

FIG. 17 is a schematic view illustrating a difference in the configuration between the white key on the low-pitched side and the white key on the high-pitched side in FIG. 10;

FIG. 18 is a schematic view illustrating a difference in the configuration between the black key on the low-pitched side and the black key on the high-pitched side in FIG. 10;

FIG. 19 is a plan view illustrating a keyboard device according to a modification of the present invention;

FIG. 20 is a right side view illustrating a configuration of a white key on a low-pitched side in the keyboard device illustrated in FIG. 19;

FIG. 21 is a right side view illustrating a configuration of a white key on a high-pitched side in the keyboard device illustrated in FIG. 19;

FIG. 22 is a right side view illustrating a configuration of a black key on a low-pitched side in the keyboard device illustrated in FIG. 19;

FIG. 23 is a right side view illustrating a configuration of a black key on a high-pitched side in the keyboard device illustrated in FIG. 19;

FIG. 24 is a right side view illustrating a configuration of a white key in a keyboard device according to another modification of the present invention;

FIG. 25 is a right side view illustrating a configuration of a black key in the keyboard device according to another modification of the present invention;

FIG. 26 is an enlarged view of the surrounding of the engagement portion according to another modification of the present invention;

FIG. 27 is a plan view illustrating a keyboard device according to a third embodiment of the present invention;

FIG. 28 is a right side view illustrating a configuration of a white key on a low-pitched side in the keyboard device illustrated in FIG. 27;

FIG. 29 is a right side view illustrating a configuration of a white key on a high-pitched side in the keyboard device illustrated in FIG. 27;

FIG. 30 is a right side view illustrating a configuration of a black key on a low-pitched side in the keyboard device illustrated in FIG. 27;

FIG. 31 is a right side view illustrating a configuration of a black key on a high-pitched side in the keyboard device illustrated in FIG. 27;

FIG. 32 is a graph of a characteristic curve illustrating a relationship between a pitch and a mass of a mass member;

FIG. 33 is a graph of a characteristic curve illustrating a relationship between a pitch and a key touch;

FIG. 34 is a schematic view illustrating a difference in the configuration between the white key on the low-pitched side and the white key on the high-pitched side in FIG. 27;

FIG. 35 is a schematic view illustrating a difference in the configuration between the black key on the low-pitched side and the black key on the high-pitched side in FIG. 27;

FIG. 36A is a side view illustrating a configuration of a white key according to a modification of the present invention;

FIG. 36B is a side view illustrating a configuration of a black key according to a modification of the present invention; and

FIG. 37 is an enlarged view of an engagement portion where a key and a hammer are engaged with each other.

### DESCRIPTION OF THE PREFERRED EMBODIMENT

A first embodiment of the present invention will be described below with reference to the drawings. In the description below, a side close to a performer is defined as a “front side”, while a side far from the performer is defined as a “rear side”. A high-pitched side is defined as a “right side”, while a low-pitched side is defined as a “left side”.

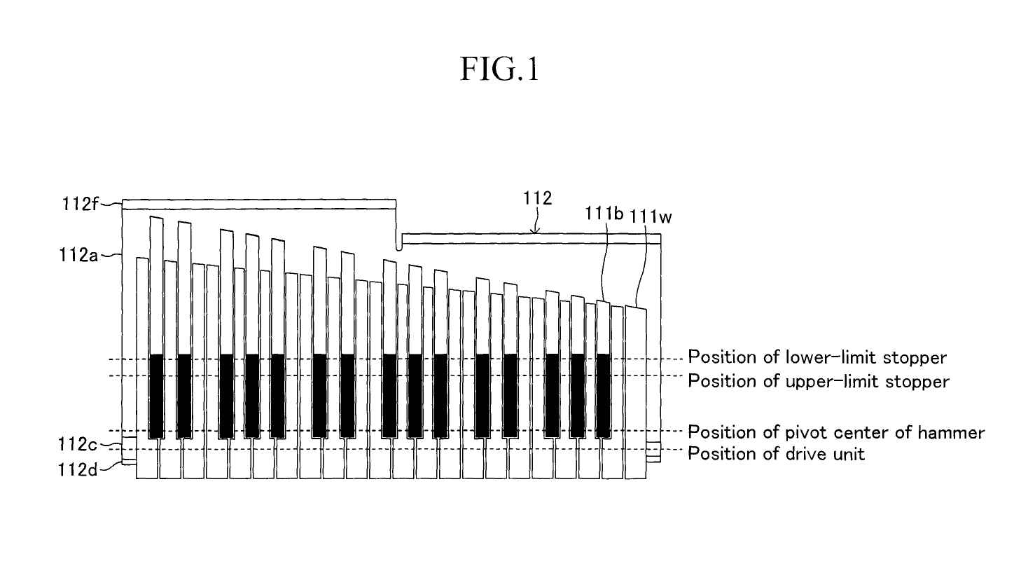

A keyboard device includes plural white keys 111w and plural black keys 111b as illustrated in FIG. 1. A different pitch is assigned to each of plural white keys 111w and each of plural black keys 111b. In the present embodiment, one of “C3”, “D3”, . . . “C6” is assigned to the white keys 111w, while one of “C#3”, “D#3”, “B#5” is assigned to the black keys 111b. The white keys 111w and black keys 111b are integrally formed to have a long shape by a synthetic resin. The white keys 111w are configured such that the length thereof is gradually shorter toward the white key 111w on the high-pitched side from the white key 111w on the low-pitched side. The black keys 111b are configured such that the length thereof is gradually shorter toward the black key 111b on the high-pitched side from the black key 111b on the low-pitched side. The back end of the black key 111b is located posterior to the back end of the adjacent white key 111w.

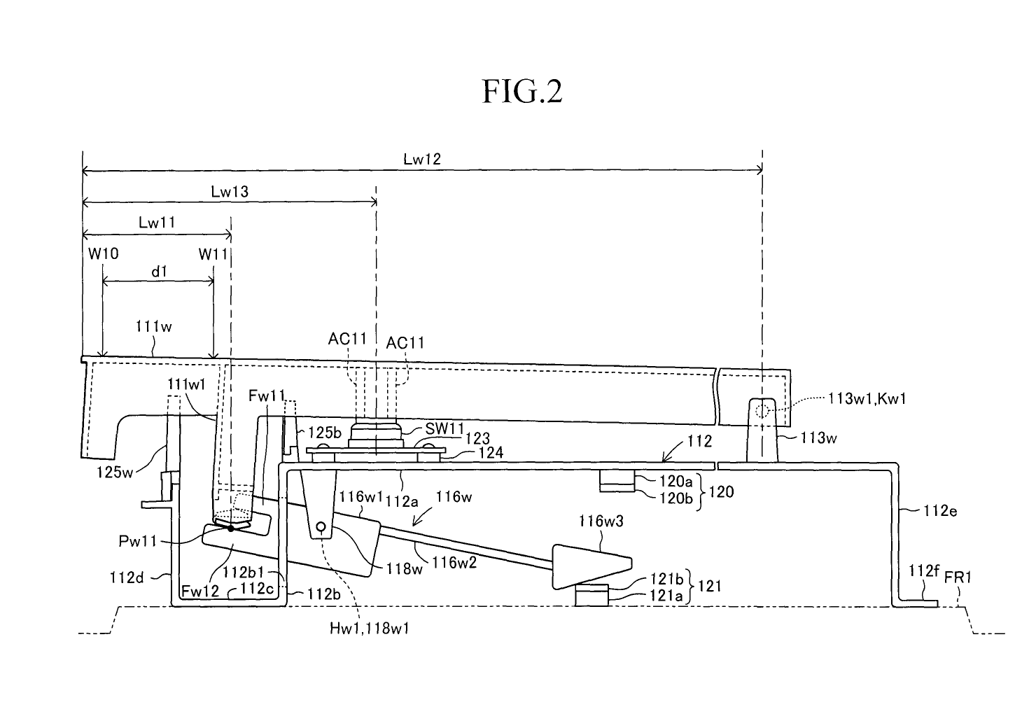

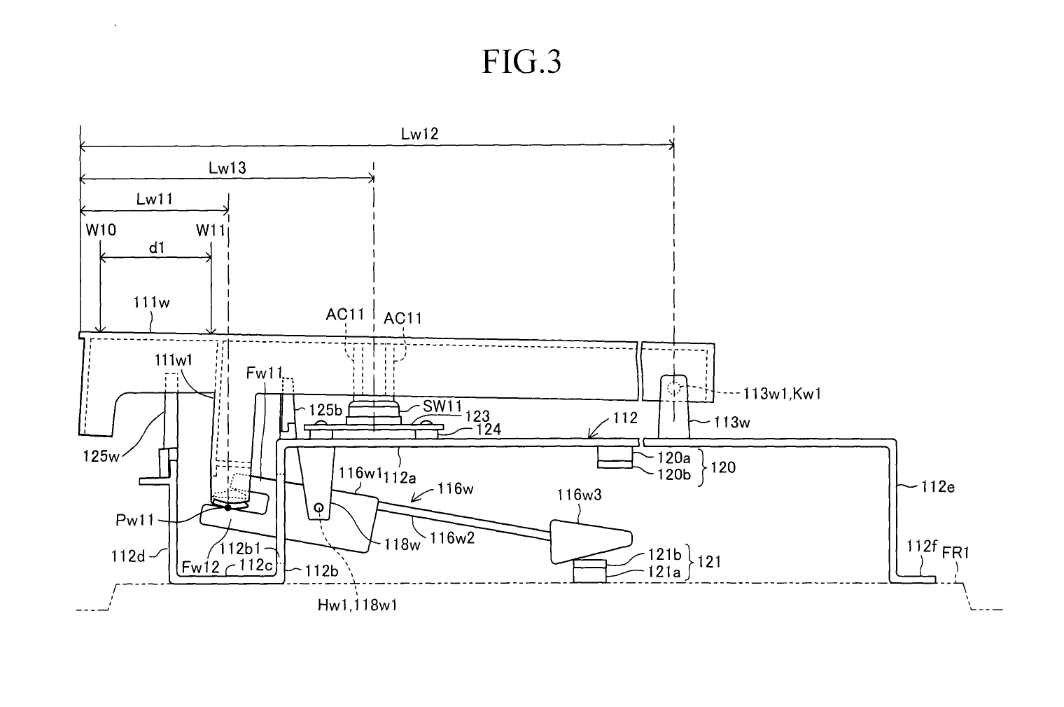

The white keys 111w, each having a different assigned pitch, have different length in the longitudinal direction, but the other structures are the same. The black keys 111b, each having a different assigned pitch, have different length in the longitudinal direction, but the other structures are the same. Each of the white keys 111w has a width in the vertical direction smaller than that of the black key 111b, and has a width in the lateral direction larger than that of the black key 111b, as illustrated in FIGS. 2 to 5. The white key 111w and the black key 111b have a hollow shape including a thin top wall extending in the longitudinal direction, and thin sidewalls extending downward from left and right ends of the top wall respectively, with no bottom.

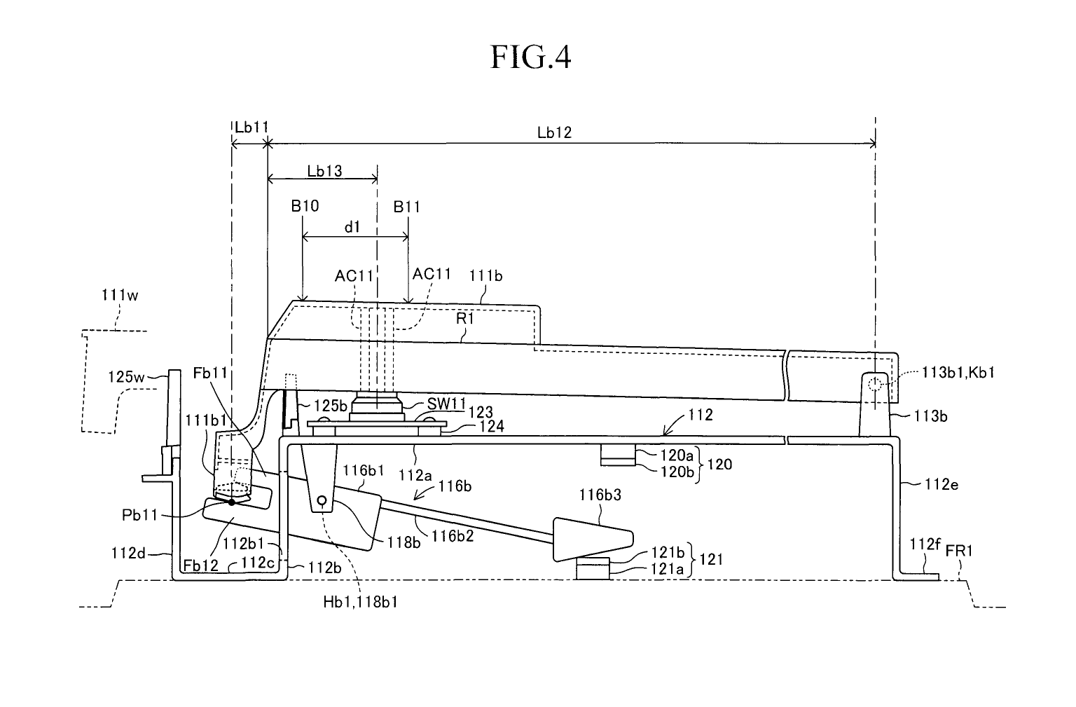

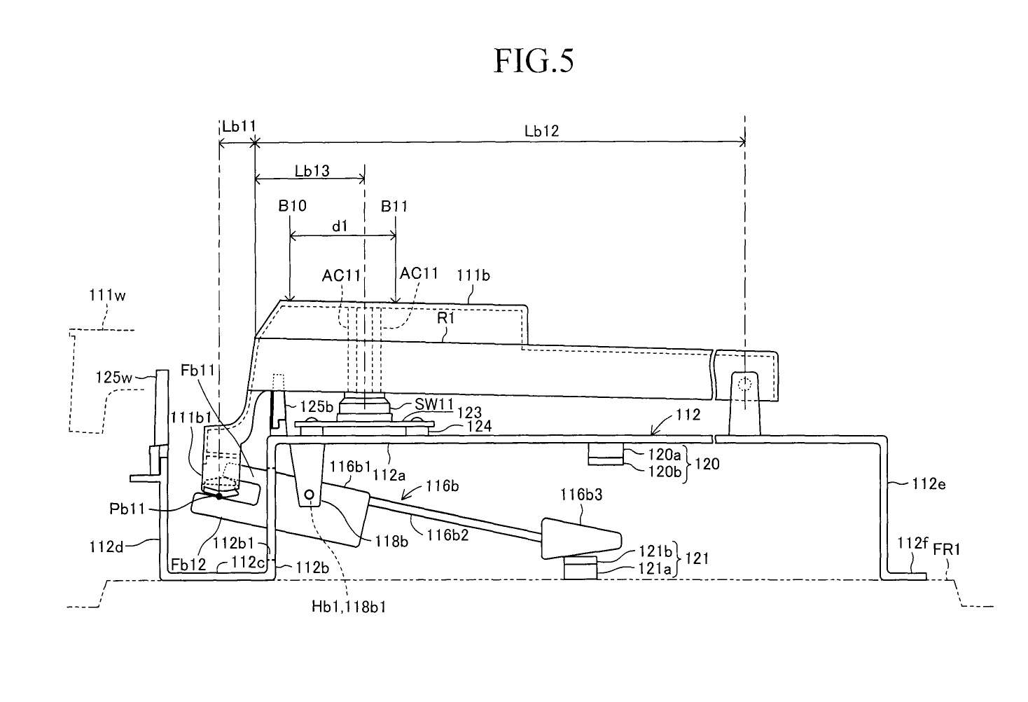

Through-holes Kw1 and Kb1 that are opposite to each other are formed on the rear part of the sidewall of the white key 111w and the black key 111b. The distance from the through-holes Kw1 and Kb1 to the back end of each key is the same for all keys. The white key 111w and the black key 111b are supported by a key support portion 113w and a key support portion 113b of a later-described key frame 112 with the through-holes Kw1 and Kb1. In the key release state, the white key 111w and the black key 111b tilt such that the back end becomes lower than the front end. The back end of the white key 111w goes into a casing of the electronic musical instrument, when the keyboard device is assembled to the electronic musical instrument. The portion of the white key anterior to the portion going into the casing is referred to as an apparent portion of the white key 111w. An edge line is formed on the portion where the side face and the top face of the white key 111w cross each other. The black key 111b has a portion projecting upward from the top face of the white key 111w in a state in which the black key 111b is not depressed, and the adjacent white keys 111w are not depressed. The projecting portion is referred to as an apparent portion of the black key 111b. The portion lower than the apparent portion of the black key 111b is referred to as a body. A performer depresses or releases the apparent portions of the white key 111w and the black key 111b. Specifically, the apparent portion corresponds to an operation portion in the present invention. The width of the apparent portion of the black key 111b in the lateral direction becomes narrower toward the top end, and the width of the body in the lateral direction is the same. Specifically, the side face of the apparent portion tilts inward with respect to the side face of the body. An edge line R1 is formed on the boundary between the apparent portion of the black key 111b and the body (see FIGS. 4 and 5).

The key frame 112 has a top plate 112a extending in the longitudinal direction and lateral direction. The position of the front end of the top plate 112a at the low-pitched side and the position of the front end at the high-pitched side are the same, but the back end at the low-pitched side is located posterior to the back end at the high-pitched side. The key frame 112 also has a front plate 112b vertically extending downward from the front end of the top plate 112a, a bottom plate 112c horizontally extending from the lower end of the front plate 112b, and a front plate 112d vertically extending upward from the front end of the bottom plate 112c. The key frame 112 also includes a rear plate 112e vertically extending downward from the back end of the top plate 112a, and a bottom plate 112f horizontally extending rearward from the lower end of the rear plate 112e. The height of the lower surface of the bottom plate 112c and the height of the lower surface of the bottom plate 112f are the same. The keyboard device is supported by a frame FR1 of an electronic musical instrument by the structure in which the lower surface of the bottom plate 112c and the lower surface of the bottom plate 112f are brought into contact with the frame FR1 of the electronic musical instrument and fixed thereto. The above-described key support portion 113w and the key support portion 113b are formed to project upward from the upper surface of the top plate 112a. The key support portion 113b is located posterior to the adjacent key support portion 113w. The key support portion 113w and the key support portion 113b respectively include two opposing plates, and a projection 113w1 and projection 113b1 that project inward. The projections 113w1 and 113b1 are fitted to the through-holes Kw1 and Kb1 respectively. Therefore, the white key 111w and the black key 111b are supported to be rotatable about the projections 113w1 and 113b1, and their front ends can rock in the vertical direction with the center axes of the through-holes Kw1 and Kb1 and the projections 113w1 and the projections 113b1 being defined as a pivot center. The position of the projection 113w1 and the position of the projection 113b1 in the vertical direction are the same for all key support portions. Specifically, the height of the pivot center is the same for all keys. The distance between the top face of the apparent portion of the white key 111w (i.e., the plane including the right and left edge lines of the white key 111w) and its pivot center in the vertical direction is the same for all white keys 111w. The distance between the top face of the operation portion of the black key 111b (i.e., the plane including the right and left edge lines of the black key 111b) and its pivot center in the vertical direction is the same for all black keys 111b.

A drive portion 111w1 extends downward from the middle portion of the apparent portion of the white key 111w. The drive portion 111w1 has a hollow shape including a thin front wall extending in the vertical direction, and thin sidewalls extending rearward from left and right ends of the front wall, with no rear wall. The lower end of the drive portion 111w1 is closed by a lower end wall. The length of the drive portion 111w1 in the vertical direction is the same for all white keys 111w. On the other hand, the black key 111b also has a drive portion 111b1 same as the drive portion 111w1 of the white key 111w. The drive portion 111b1 has a connection portion that extends downward from the front end of the apparent portion of the black key 111b and that is slightly curved to the front, and a vertical portion projecting downward from the leading end of the connection portion. The configuration of the vertical portion is the same for the drive portion 111w1. The length of the drive portion 111b1 in the vertical direction is the same for all black keys 111b.

A distance Lw11 from the front end of the white key 111w to the drive portion 111w1 in the longitudinal direction is within 30% of a distance Lw12 from the front end of the white key 111w with the highest pitch (i.e., the shortest key of the plural white keys 111w) to the through-hole Kw1. The distance Lw11 is the same for all white keys 111w. A distance Lb11 from the front end of the apparent portion of the black key 111b to the drive portion 111b1 in the longitudinal direction is within 30% of a distance Lb12 from the front end of the apparent portion of the black key 111b with the highest pitch (e.g., the shortest key of the plural black keys 111b) to the through-hole Kb1. The distance Lb11 is the same for all black keys 111b. The position of the drive portion 111w1 and the position of the drive portion 111b1 in the longitudinal direction in the key-released state of the white key 111w and the black key 111b are the same. Specifically, the drive portions 111w1 and the drive portions 111b1 are located anterior to the front end of the apparent portion of the black keys 111b, and the drive portions 111w1 and the drive portions 111b1 are arranged in the lateral direction.

The lower ends of the drive portion 111w1 and the drive portion 111b1 are respectively engaged with front ends of hammers 116w and 116b in the opening formed between the front plate 112b and the front plate 112d. As described in detail later, the hammer 116w and the hammer 116b rock with the rocking movement of the corresponding white key 111w and the black key 111b with which the respective hammers 116w and 116b are engaged.

The hammer 116w includes a base 116w1 made of synthetic resin, a connection rod 116w2 made of metal, and a mass member 116w3. Like the hammer 116w, the hammer 116b includes a base 116b1, a connection rod 116b2, and a mass member 116b3. The base 116w1 and the base 116b1 are plate-like members, and formed with through-holes Hw1 and Hb1, respectively, from the right side face to the left side face. A hammer support portion 118w and a hammer support portion 118b are formed to project downward from the lower surface of the top plate 112a. The hammer support portions 118w and 118b are formed to have two opposing plates, and respectively have projections 118w1 and 118b1 projecting inward. The projections 118w1 and 118b1 are respectively fitted to the through-holes Hw1 and Hb1. With this structure, the bases 116w1 and 116b1 are supported to be rotatable about the projections 118w1 and 118b1. Specifically, the hammer 116w and the hammer 116b are supported such that the front ends and the back ends can be rocked in the vertical direction. The positions of the hammer support portion 118w and the hammer support portion 118b in the longitudinal direction and in the vertical direction are the same for all hammer support portions 118w and 118b. The positions of the projections 118w1 and 118b1 in the longitudinal direction are the same for all hammer support portions 118w and hammer support portions 118b. The projection 118w1 of the hammer support portion 118w of the hammer 116w for the white key 111w to which the higher pitch is assigned is located on a lower position. The projection 118b1 of the hammer support portion 118b of the hammer 116b for the black key 111b to which the higher pitch is assigned is located on a higher position.

The base 116w1 includes a pair of leg portion Fw11 and leg portion Fw12 on its front end. The upper leg portion Fw11 is formed to be shorter than the lower leg portion Fw12. Like the base 116w1, the base 116b1 includes a pair of leg portion Fb11 and leg portion Fb12 on its front end. An elongated slit-like opening 112b1 extending in the vertical direction is formed on the front plate 112b for each of the hammers 116w and 116b. The front end of each hammer 116w and the front end of each hammer 116b project forward of the front plate 112b through the opening 112b1. The wall of the lower end of the drive portion 111w1 enters between the leg portions Fw11 and Fw12, while the wall of the lower end of the drive portion 111b1 enters between the leg portions Fb11 and Fb12. Specifically, the leg portions Fw11 and Fb11 enter between the walls of the lower ends of the drive portions 111w1 and 111b1 and intermediate walls that form gaps with the walls of the lower ends in the drive portions 111w1 and 111b1. Shock absorbing members such as rubber, urethane, or felt are fitted and fixed on the wall of the lower end of each of the drive portions 111w1 and 111b1. The shock absorbing members attenuates shock caused by the collision between the lower end of the drive portion 111w1 and the upper surface of the leg portion Fw12, the collision between the lower end of the drive portion 111b1 and the upper surface of the leg portion Fb12, the collision between the lower end of the drive portion 111w1 and the lower surface of the leg portion Fw11, and the collision between the lower end of the drive portion 111b1 and the lower surface of the leg portion Fb11.

The front end of the connection rod 116w2 and the front end of the connection rod 116b2 are assembled to the back end of the base 116w1 and the back end of the base 116b1, respectively. The connection rods 116w2 and 116b2 extend rearward. The position of the back end of the connection rod 116w2 and the position of the back end of the connection rod 116b2 in the longitudinal direction are the same. The mass member 116w3 and the mass member 116b3, described later, are assembled to the back end of the connection rod 116w2 and the back end of the connection rod 116b2, respectively.

The mass member 116w3 and the mass member 116b3 are formed to have a plate-like shape. The mass member 116w3 and the mass member 116b3 are long in the longitudinal direction. The mass member 116w3 and the mass member 116b3 are assembled to the connection rods 116w2 and 116b2 in such a manner that the thickness thereof is along the lateral direction. In the key release state, the lower surface of the mass member 116w3 tilts with respect to the top surface of the frame FR1, and the back side of the lower surface of the mass member 116w3 is located to be higher than the front side. In the key release state, the lower surface of the mass member 116b3 tilts with respect to the top surface of the frame FR1, and the back side of the lower surface of the mass member 116b3 is located to be higher than the front side. In the key depression state, the top surfaces of the mass member 116w3 and the mass member 116b3 are parallel to the lower surface of the top plate 112a of the key frame 112. The appearance of the mass member 116w3 is the same for all hammers 116w. The appearance of the mass member 116b3 is also the same for all hammers 116b.

As described above, the position of the pivot point of the key is different depending upon the assigned pitch. Therefore, the distance from the pivot center of the white key 111w to an engagement portion Pw11 where the leg portion Fw12 and the drive portion 111w1 are engaged with each other (brought into contact with each other) is different depending upon the assigned pitch. The distance from the pivot center of the black key 111b to an engagement portion Pb11 where the leg portion Fb12 and the drive portion 111b1 are engaged with each other (brought into contact with each other) is also different depending upon the assigned pitch. A key depression/release operation position W10 of the white key 111w that is the front end of the position of the white key 111w with the potentiality of being depressed or released is located anterior to the engagement portion Pw11, while a key depression/release operation position B10 of the black key 111b that is the front end of the position of the black key 111b with the potentiality of being depressed or released is located posterior to the engagement portion Pb11. Therefore, if the masses of the mass members for all hammers are equal, a key touch feeling is heavier on the middle-pitched part than on the low-pitched part, and the key touch feeling is heavier on the high-pitched part than on the middle-pitched part, on the key depression/release operation positions W10 and B10, because of the principle of leverage.

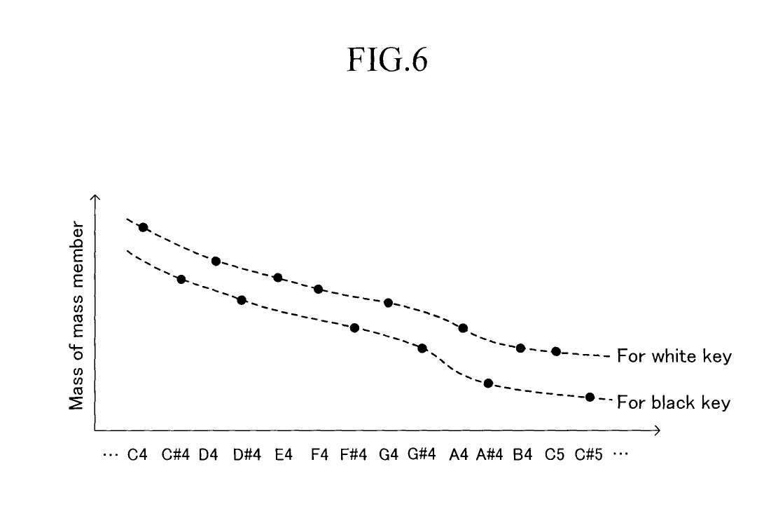

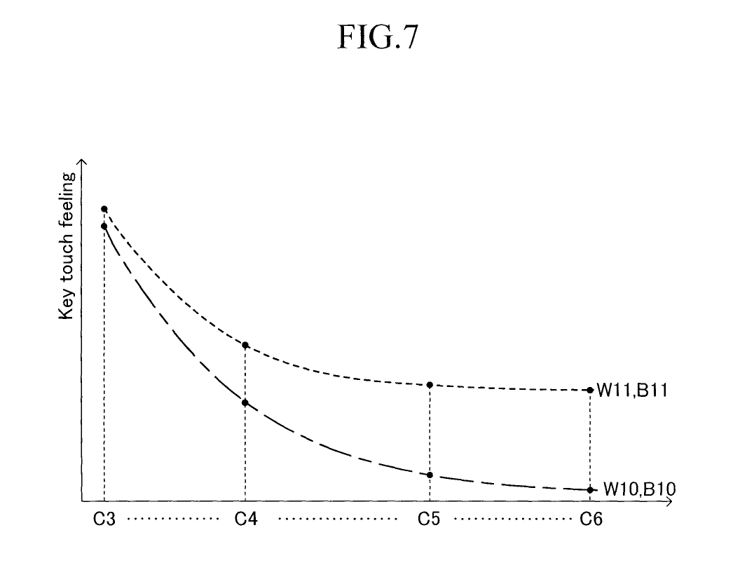

In addition, in this case, the key touch feeling of the white keys 111w and the black keys 111b in each range is not equal. Specifically, the key touch feeling of the black key 111b is heavier than the key touch feeling of the adjacent two white keys 111w. In view of this, the mass of the mass member 116w3 and the mass of the mass member 116b3 are adjusted for each key as illustrated in FIG. 6. Specifically, as illustrated in a characteristic curve indicating the masses of the mass members 116w3 and 116b3 in the order of pitches, the masses of the mass members 116w3 and 116b3 are adjusted such that the characteristic curve of the mass member 116w3 and the characteristic curve of the mass member 116b3 are parallel downward-sloping curves, wherein the characteristic curve of the mass member 116b3 is located below the characteristic curve of the mass member 116w3. Thus, as illustrated by a chain line in FIG. 7, the key touch feeling on the key depression/release operation positions W10 and B10 becomes gradually lighter toward the high-pitched side from the low-pitched side. Therefore, as illustrated by a broken line in FIG. 7, the key touch feeling on key depression/release operation positions W11 and B11 located posterior to the key depression/release operation positions W10 and B10 by a distance d1 also becomes gradually lighter toward the high-pitched side from the low-pitched side. Since the length of the key to which a higher pitch is assigned is shorter, the difference between the key touch feeling on the key depression/release operation positions W10 and B10 and the key touch feeling on the key depression/release operation positions W11 and B11 becomes larger toward the high-pitched side from the low-pitched side. Specifically, the difference in the key touch feeling caused by the longitudinal difference of the key depression/release operation position is small on the low-pitched side, moderate in the middle-pitched side, and large on the high-pitched side.

When the white key 111w and the black key 111b are released, the front ends of the hammers 116w and 116b displace upward due to their own weight of the hammers 116w and 116b. In this case, the drive portion 111w1 and the drive portion 111b1 are biased upward by the leg portion Fw12 and the leg portion Fb12 respectively, whereby the front ends of the white key 111w and the black key 111b displace upward. On the other hand, when the white key 111w and the black key 111b are depressed, the lower surfaces of the drive portion 111w1 and the drive portion 111b1 press the upper surfaces of the leg portion Fw12 and the leg portion Fb12 respectively, whereby the front ends of the hammer 116w and the hammer 116b respectively displace downward.

A lower-limit stopper 120 is provided to the key frame 112. During the key depression, the lower-limit stopper 120 is brought into contact with the upper surfaces of the mass member 116w3 and the mass member 116b3 of the hammer 116w and the hammer 116b so as to restrict the upward displacement of the back ends of the hammer 116w and the hammer 116b, thereby restricting the downward displacement of the front ends of the white key 111w and the black key 111b. The lower-limit stopper 120 includes a stopper rail 120a and a buffer member 120b. The stopper rail 120a protrudes downward from the lower surface at the middle of the top plate 112a, and extends parallel to the arrangement direction of the keys. The projection amount of the stopper rail 120a from the lower surface of the top plate 112a on the contact portion between the stopper rail 120a and each hammer is constant in the lateral direction. The buffer member 120b is fixed to the lower end surface of the stopper rail 120a. The buffer member 120b is a long member made of a shock-absorbing member such as rubber or felt. The sectional shape of the buffer member 120b is uniform from one end to the other end.

An upper-limit stopper 121 is provided to the middle portion of the frame FR1. During the key release, the upper-limit stopper 121 is brought into contact with the lower surfaces of the mass member 116w1 and the mass member 116b1 of the hammer 116w and the hammer 116b so as to restrict the downward displacement of the back ends of the hammer 116w and the hammer 116b, thereby restricting the upward displacement of the front ends of the white key 111w and the black key 111b. Like the lower-limit stopper 120, the upper-limit stopper 121 includes a stopper rail 121a and a buffer member 121b. Specifically, the stopper rail 121a also extends parallel to the arrangement direction of the keys, and the projection amount thereof from the frame FR1 is constant in the lateral direction. The buffer member 121b is fixed on the upper surface of the stopper rail 121a. Like the buffer member 120b, the sectional shape of the buffer member 121b is uniform from one end to the other end. The stopper rail 120a and the stopper rail 121a may continuously extend in the lateral direction, or may discontinuously extend. The stopper rail 120a and the stopper rail 121a may be formed integral with the top plate 112a and the frame FR1 respectively, or may be formed as separate components and assembled to the top plate 112a and the frame FR1 respectively.

As described above, the projection 118w1 of the hammer support portion 118w of the hammer 116w for the white key 111w to which a higher pitch is assigned is located on a lower position. Therefore, during the key release, the engagement portion Pw11 between the hammer 116w and the drive portion 111w1 on the high-pitched side is located to be lower than the engagement portion Pw11 between the hammer 116w and the drive portion 111w on the low-pitched side.

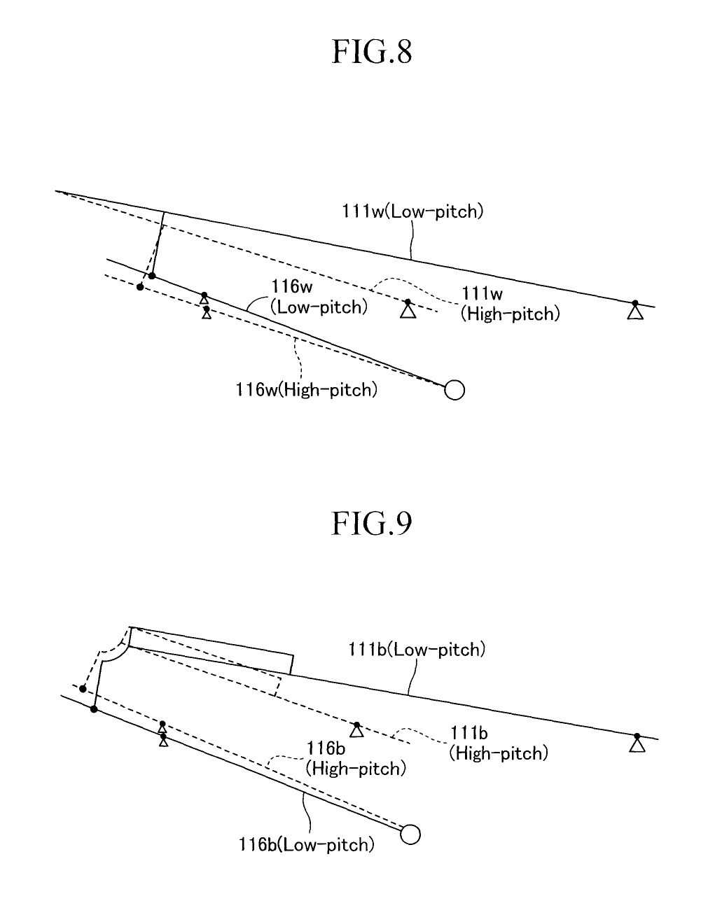

As described above, the white key 111w tilts such that the back end is lower than the front end during the key release. The length of the drive portion 111w1 in the vertical direction is the same for all white keys 111w. The height of the pivot center is the same for all white keys 111w. Accordingly, if the position of the engagement portion Pw11 in the vertical direction is the same during the key release, the front end of the white key 111w having the shorter length in the longitudinal direction might become high. In view of this, in the present embodiment, the projection 118w1 of the hammer support portion 118w of the hammer 116w for the white key 111w to which a higher pitch is assigned is located on a lower position. With this structure, the engagement portion Pw11 of the white key 111w on the high-pitched side is located to be lower than the engagement portion Pw11 of the white key 111w on the low-pitched side, whereby the height of the front ends of all white keys 111w is adjusted to be the same (see FIG. 8). Specifically, the position of the projection 118w1 in the vertical direction is set according to the length of the white key 111w in order to adjust the height of the front ends of all white keys 111w during the key release to be the same.

As described above, the projection 118b1 of the hammer support portion 118b of the hammer 116b for the black key 111b to which a higher pitch is assigned is located on a higher position. Therefore, during the key release, the engagement portion Pb11 between the hammer 116b and the drive portion 111b1 on the high-pitched side is located to be higher than the engagement portion Pb11 between the hammer 116b and the drive portion 111b on the low-pitched side.

As described above, the black key 111b tilts such that the back end is lower than the front end during the key release. The length of the drive portion 111b1 in the vertical direction is the same for all black keys 111b. The height of the pivot center is the same for all black keys 111b. Accordingly, if the position of the engagement portion Pb11 in the vertical direction is the same during the key release, the front end of the black key 111b having the shorter length in the longitudinal direction might become low. In view of this, in the present embodiment, the projection 118b1 of the hammer support portion 118b of the hammer 116b for the black key 111b to which a higher pitch is assigned is located on a higher position. With this structure, the engagement portion Pb11 of the black key 111b on the high-pitched side is located to be higher than the engagement portion Pb11 of the black key 111b on the low-pitched side, whereby the height of the front ends of all black keys 111b is adjusted to be the same (see FIG. 9). Specifically, the position of the projection 118b1 in the vertical direction is set according to the length of the black key 111b in order to adjust the height of the front ends of all black keys 111b during the key release to be the same.

In a state in which two adjacent white keys 111w and the black key 111b between the two adjacent white keys 111w are released, the rocking angle of each hammer is set such that the edge line R1 of the black key 111b is located below the top face of one on the low-pitched side of the two white keys 111w, and above the top face of one on the high-pitched side of the two white keys 111w.

The rocking angle of each hammer is set such that, in the state in which the white key 111w and the black key 111b adjacent to the white key 111w are depressed respectively by the same depression force, and their rocking movement is restricted, the edge line R1 of the black key 111b is located below the top face of the white key 111w. The buffer member 120b and the buffer member 121b have elasticity. Therefore, when the key is depressed more after the hammer is brought into the buffer member during the key depression, the buffer member is elastically deformed, so that the front end of the key slightly displaces downward.

A switch drive portion AC11 is provided on the lower surface of each of the white key 111w and the black key 111b on the middle part. The switch drive portion AC11 is a plate-like member extending in the vertical direction in each of the white key 111w and the black key 111b, and the lower end surface of the switch drive portion AC11 is brought into contact with the upper surface of a switch SW11. The switch SW11 is provided for each key. The switch SW11 is pressed by the corresponding key to detect whether the corresponding key is depressed or released. Specifically, when the switch SW11 is depressed by the key, a rubber main body is deformed to make two contacts, which are formed on a circuit board 123, short-circuit, thereby being turned ON. The circuit board 123 extends in the lateral direction. Through-holes penetrating from the upper surface to the lower surface are formed on the circuit board 123. The through-holes correspond to a bosses 124 formed integral with the upper surface of the top plate 112a. When screws are threaded to the bosses 124 through the through-holes, the circuit board 123 is fixed to the key frame 112. The main bodies of the plural switches SW11, each corresponding to each key, are arranged on the upper surface of the circuit board 123 in the lateral direction. The position of the switch SW11 for the white key 111w and the position of the switch SW11 for the black key 111b in the longitudinal direction are the same. A distance Lw13 from the front end of the white key 111w to the switch SW11 in the longitudinal direction is within 30% of the distance Lw12 from the front end of the white key 111w with the highest pitch to the through-hole Kw1, and a distance Lb13 from the front end of the apparent portion of the black key 111b to the switch SW11 is within 30% of the distance Lb12 from the front end of the apparent portion of the black key 111b with the highest pitch to the through-hole Kb1. The switch SW11 for the white key 111w and the switch SW11 for the black key 111b may be arranged side by side in the lateral direction, and the positions of both switches in the longitudinal direction may be shifted.

A key guide 125w for guiding the rocking movement of the white key 111w is formed to project upward from the top end surface of the front plate 112d. The key guide 125w is inserted into the white key 111w from below, and during the key depression and key release, the side face of the key guide 125w and the inside face of the sidewall of the white key 111w are in sliding contact with each other. This structure can prevent a slight displacement of the white key 111w in the lateral direction during the key depression and key release.

A key guide 125b for guiding the rocking movement of the black key 111b is formed to project upward from the upper surface of the top plate 112a at the front end. The key guide 125b is inserted into the black key 111b from below, and during the key depression and key release, the side face of the key guide 125b and the inside face of the sidewall of the black key 111b are in sliding contact with each other. This structure can prevent a slight displacement of the black key 111b in the lateral direction during the key depression and key release.

In the keyboard device having the configuration described above, the height of the front ends of the keys during the key release is adjusted to be the same, whereby the appearance of the key board device can be made similar to the appearance of the keyboard device for an acoustic piano during the key release. In addition, the keyboard device according to the present embodiment has high productivity, compared to the keyboard device for an acoustic piano in which the height of the front ends of the keys is adjusted to be the same by adjusting the number or the thickness of spacer, which is sandwiched between the key support portion and the frame.

The distance from the top face of the apparent portion of the white key 111w to the pivot center is the same for all white keys 111w, and the distance from the top face of the body of the black key 111b to the pivot center is the same for all black keys 111b. Accordingly, when the through-holes Kw1 and Kb1 are formed in a different process after a process of molding the outer shape of the white key 111w and the black key 111b, the different process can commonly be carried out for all keys to enhance productivity of the keys. The positions of the projections 113w1 and 113b1 of the key support portions 113w and 113b in the vertical direction are set to be the same for all key support portions 113w and 113b, resulting in that the frame 112 that supports the keys is easily designed. In addition, the frame 112 is easily processed, and the precision can be enhanced.

In the embodiment described above, the white key 111w and the black key 111b are supported by the key support portions 113w and 113b of the key frame 112 by fitting the projections 113w1 and 113b1 to the through-holes Kw1 and Kb1 respectively so that the front ends of the white key 111w and the black key 111b can rock in the vertical direction. However, the white key 111w and the black key 111b can be mounted on the key frame 112 by using various supporting mechanisms, if the white key 111w and the black key 111b are supported by the key frame 112 so that the front ends of the white key 111w and the black key 111b can rock in vertical direction. For example, the rear ends of plural keys (the white key 111w and/or the black key 111b) may be are supported by the key frame 112 through elastic deformation members so that the front ends of the plural keys can rock in vertical direction. Concretely, the rear ends of the plural keys are connected to a fixing member fixed to the key frame 112 through thin and elastic connection members, wherein the fixing member is extended in the lateral direction, the connection members are extended horizontally or vertically, and the plural keys, the connection members and the fixing member are formed integrally. In this case, for example, the connection members for the white keys 111w are extended horizontally, and the connection members for the black keys 111b are extended vertically.

Subsequently, a second embodiment of the present invention will be described below with reference to the drawings. In the description below, a side close to a performer is defined as a “front side”, while a side far from the performer is defined as a “rear side”. A high-pitched side is defined as a “right side”, while a low-pitched side is defined as a “left side”.

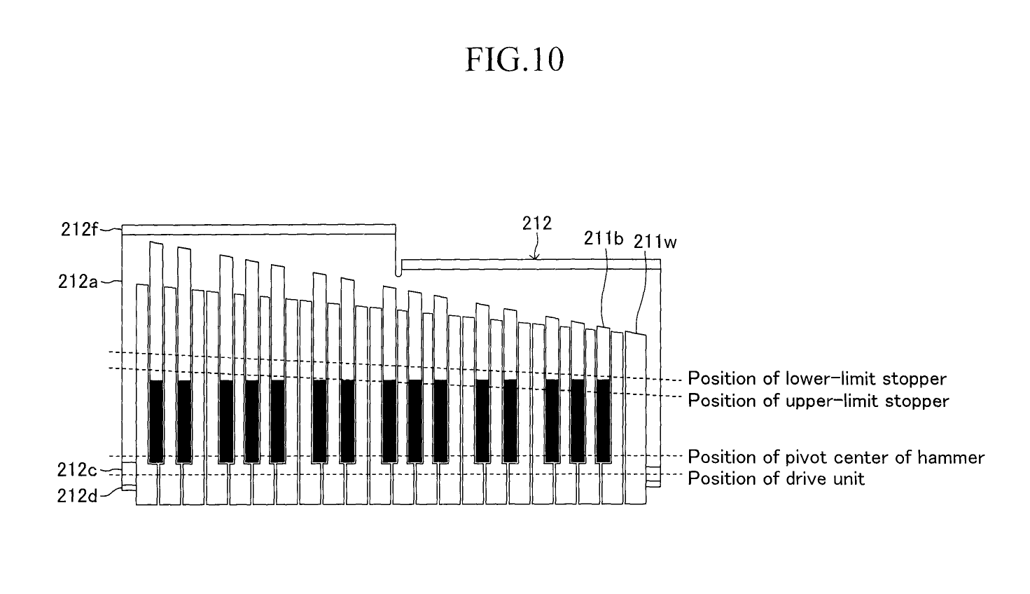

A keyboard device includes plural white keys 211w and plural black keys 211b as illustrated in FIG. 10. A different pitch is assigned to each of plural white keys 211w and each of plural black keys 211b. In the present embodiment, one of “C3”, “D3”, . . . “C6” is assigned to the white keys 211w, while one of “C#3”, “D#3”, “B#5” is assigned to the black keys 211b. The white keys 211w and black keys 211b are integrally formed to have a long shape by a synthetic resin. The white keys 211w are configured such that the length thereof is gradually shorter toward the white key 211w on the high-pitched side from the white key 211w on the low-pitched side. The black keys 211b are configured such that the length thereof is gradually shorter toward the black key 211b on the high-pitched side from the black key 211b on the low-pitched side. The back end of the black key 211b is located posterior to the back end of the adjacent white key 211w.

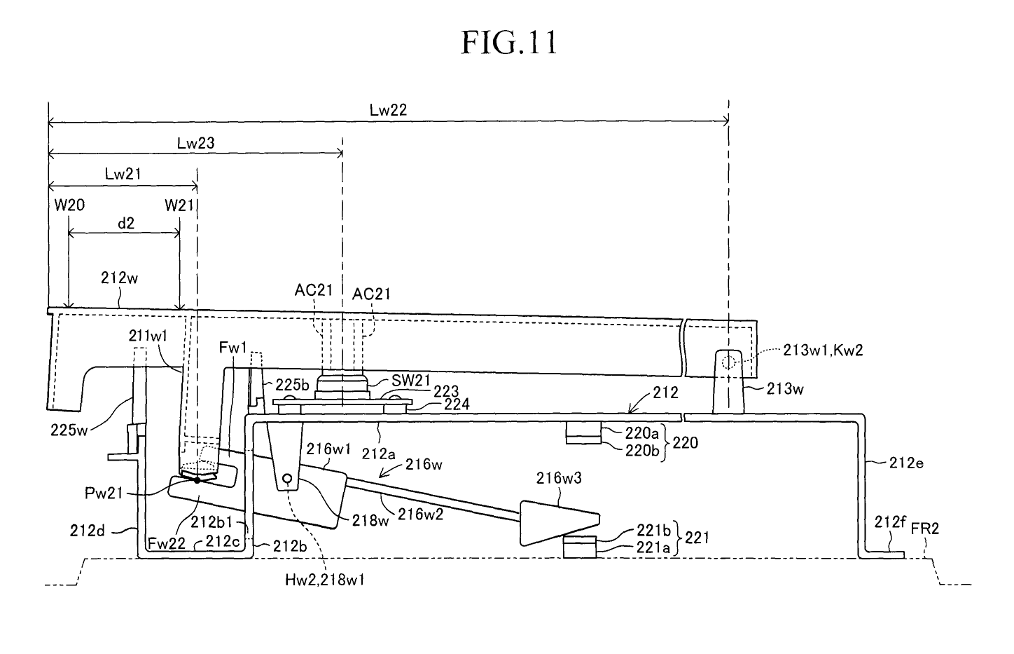

The white keys 211w, each having a different assigned pitch, have different length in the longitudinal direction, but the other structures are the same. The black keys 211b, each having a different assigned pitch, have different length in the longitudinal direction, but the other structures are the same. Each of the white keys 211w has a width in the vertical direction smaller than that of the black key 211b, and has a width in the lateral direction larger than that of the black key 211b, as illustrated in FIGS. 11 to 14. The white key 211w and the black key 211b have a hollow shape including a thin top wall extending in the longitudinal direction, and thin sidewalls extending downward from left and right ends of the top wall respectively, with no bottom.

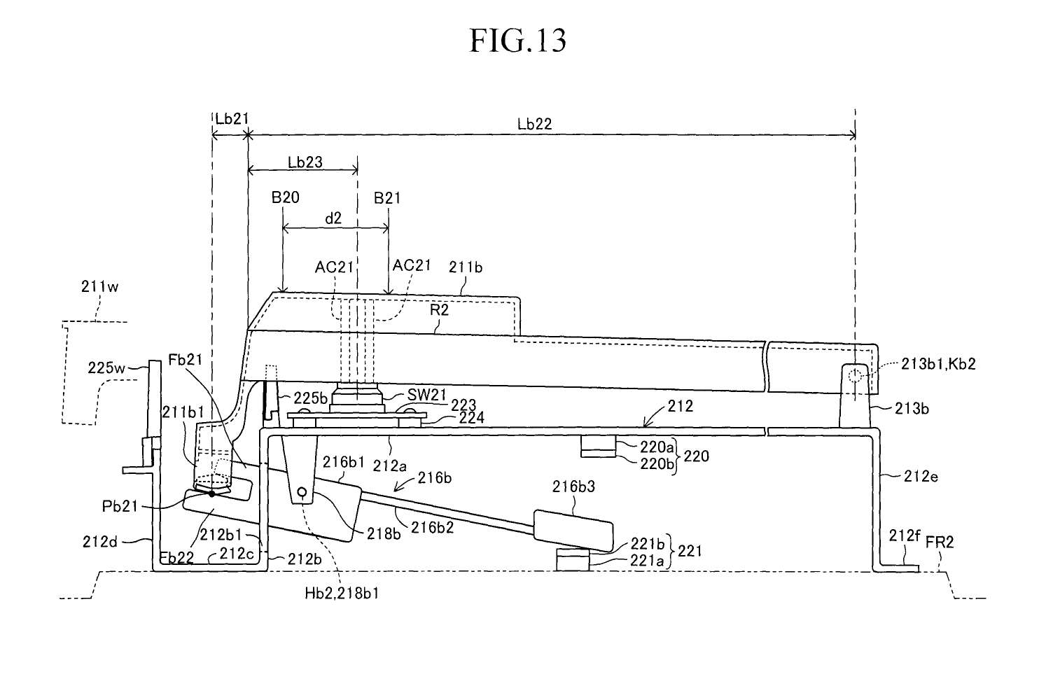

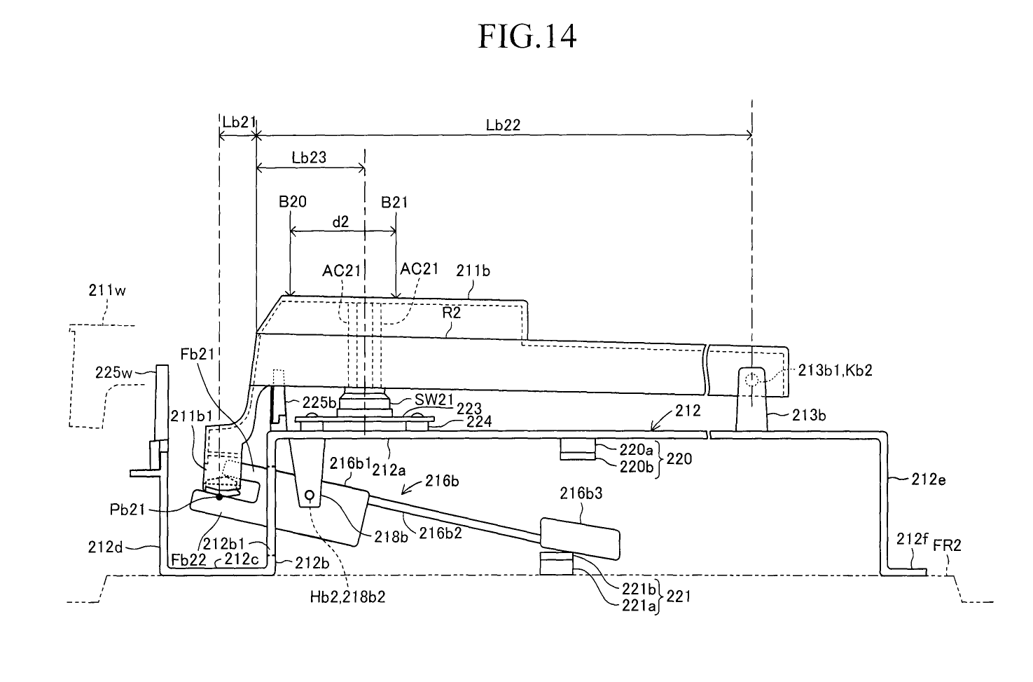

Through-holes Kw2 and Kb2 that are opposite to each other are formed on the rear part of the sidewall of the white key 211w and the black key 211b. The distance from the through-holes Kw2 and Kb2 to the back end of each key is the same for all keys. The white key 211w and the black key 211b are supported by a key support portion 213w and a key support portion 213b of a later-described key frame 212 with the through-holes Kw2 and Kb2. In the key release state, the white key 211w and the black key 211 tilt such that the back end becomes lower than the front end. The back end of the white key 211w goes into a casing of the electronic musical instrument, when the keyboard device is assembled to the electronic musical instrument. The portion of the white key anterior to the portion going into the casing is referred to as an apparent portion of the white key 211w. An edge line is formed on the portion where the side face and the top face of the white key 211w cross each other. The black key 211b has a portion projecting upward from the top face of the white key 211w in a state in which the black key 211b is not depressed, and the adjacent white keys 211w are not depressed. The projecting portion is referred to as an apparent portion of the black key 211b. The portion lower than the apparent portion of the black key 211b is referred to as a body. A performer depresses or releases the apparent portions of the white key 211w and the black key 211b. Specifically, the apparent portion corresponds to an operation portion in the present invention. The width of the apparent portion of the black key 211b in the lateral direction becomes narrower toward the top end, and the width of the body in the lateral direction is the same. Specifically, the side face of the apparent portion tilts inward with respect to the side face of the body. An edge line R2 is formed on the boundary between the apparent portion of the black key 211b and the body (see FIGS. 13 and 14).

The key frame 212 has a top plate 212a extending in the longitudinal direction and lateral direction. The position of the front end of the top plate 212a at the low-pitched side and the position of the front end at the high-pitched side are the same, but the back end at the low-pitched side is located posterior to the back end at the high-pitched side. The key frame 212 also has a front plate 212b vertically extending downward from the front end of the top plate 212a, a bottom plate 212c horizontally extending from the lower end of the front plate 212b, and a front plate 212d vertically extending upward from the front end of the bottom plate 212c. The key frame 212 also includes a rear plate 212e vertically extending downward from the back end of the top plate 212a, and a bottom plate 212f horizontally extending rearward from the lower end of the rear plate 212e. The height of the lower surface of the bottom plate 212c and the height of the lower surface of the bottom plate 212f are the same. The keyboard device is supported by a frame FR2 of an electronic musical instrument by the structure in which the lower surface of the bottom plate 212c and the lower surface of the bottom plate 212f are brought into contact with the frame FR2 of the electronic musical instrument and fixed thereto. The above-described key support portion 213w and the key support portion 213b are formed to project upward from the upper surface of the top plate 212a. The key support portion 213b is located posterior to the adjacent key support portion 213w. The key support portion 213w and the key support portion 213b respectively include two opposing plates, and a projection 213w1 and projection 213b1 that project inward. The projections 213w1 and 213b1 are fitted to the through-holes Kw2 and Kb2 respectively. Therefore, the white key 211w and the black key 211b are supported to be rotatable about the projections 213w1 and 213b1, and their front ends can rock in the vertical direction with the center axes of the through-holes Kw2 and Kb2 and the projections 213w1 and the projections 213b1 being defined as a pivot center. The position of the projection 213w1 and the position of the projection 213b1 in the vertical direction are the same for all key support portions. Specifically, the height of the pivot center is the same for all keys. The distance between the top face of the apparent portion of the white key 211w (i.e., the plane including the right and left edge lines of the white key 211w) and its pivot center in the vertical direction is the same for all white keys 211w. The distance between the top face of the operation portion of the black key 211b (i.e., the plane including the right and left edge lines of the black key 211b) and its pivot center in the vertical direction is the same for all black keys 211b.

A drive portion 211w1 extends downward from the middle portion of the apparent portion of the white key 211w. The drive portion 211w1 has a hollow shape including a thin front wall extending in the vertical direction, and thin sidewalls extending rearward from left and right ends of the front wall, with no rear wall. The lower end of the drive portion 211w1 is closed by a lower end wall. The length of the drive portion 211w1 in the vertical direction is the same for all white keys 211w. On the other hand, the black key 211b also has a drive portion 211b1 same as the drive portion 211w1 of the white key 211w. The drive portion 211b1 has a connection portion that extends downward from the front end of the apparent portion of the black key 211b and that is slightly curved to the front, and a vertical portion projecting downward from the leading end of the connection portion. The configuration of the vertical portion is the same for the drive portion 211w1. The length of the drive portion 211b1 in the vertical direction is the same for all black keys 211b.

A distance Lw21 from the front end of the white key 211w to the drive portion 211w1 in the longitudinal direction is within 30% of a distance Lw22 from the front end of the white key 211w with the highest pitch (i.e., the shortest key of the plural white keys 211w) to the through-hole Kw2. The distance Lw21 is the same for all white keys 211w. A distance Lb21 from the front end of the apparent portion of the black key 211b to the drive portion 211b1 in the longitudinal direction is within 30% of a distance Lb22 from the front end of the apparent portion of the black key 211b with the highest pitch (e.g., the shortest key of the plural black keys 211b) to the through-hole Kb2. The distance Lb21 is the same for all black keys 211b. The position of the drive portion 211w1 and the position of the drive portion 211b1 in the longitudinal direction in the key-released state of the white key 211w and the black key 211b are the same. Specifically, the drive portions 211w1 and the drive portions 211b1 are located anterior to the front end of the apparent portion of the black keys 211b, and the drive portions 211w1 and the drive portions 211b1 are arranged in the lateral direction.

The lower ends of the drive portion 211w1 and the drive portion 211b1 are respectively engaged with front ends of hammers 216w and 216b in the opening formed between the front plate 212b and the front plate 212d. As described in detail later, the hammer 216w and the hammer 216b rock with the rocking movement of the corresponding white key 211w and the black key 211b with which the respective hammers 216w and 216b are engaged.

The hammer 216w includes a base 216w1 made of synthetic resin, a connection rod 216w2 made of metal, and a mass member 216w3. Like the hammer 216w, the hammer 216b includes a base 216b1, a connection rod 216b2, and a mass member 216b3. The base 216w1 and the base 216b1 are plate-like members, and formed with through-holes Hw2 and Hb2, respectively, from the right side face to the left side face. A hammer support portion 218w and a hammer support portion 218b are formed to project downward from the lower surface of the top plate 212a. The hammer support portions 218w and 218b are formed to have two opposing plates, and respectively have projections 218w1 and 218b1 projecting inward. The projections 218w1 and 218b1 are respectively fitted to the through-holes Hw2 and Hb2. With this structure, the bases 216w1 and 216b1 are supported to be rotatable about the projections 218w1 and 218b1. Specifically, the hammer 216w and the hammer 216b are supported such that the front ends and the back ends can be rocked in the vertical direction. The positions of the hammer support portion 218w and the hammer support portion 218b in the longitudinal direction and in the vertical direction are the same for all hammer support portions 218w and 218b. Specifically, plural hammer support portions 218w and the plural hammer support portions 218b are arranged side by side in the lateral direction, and the positions of the pivot centers of all hammers 216w and hammers 216b in the longitudinal direction and in the vertical direction are the same for all hammers 216w and 216b. In other words, the pivot centers of the hammers 216w and the hammers 216b are located on the same straight line extending in the lateral direction.

The base 216w1 includes a pair of leg portion Fw21 and leg portion Fw22 on its front end. The upper leg portion Fw21 is formed to be shorter than the lower leg portion Fw22. Like the base 216w1, the base 216b1 includes a pair of leg portion Fb21 and leg portion Fb22 on its front end. An elongated slit-like opening 212b1 extending in the vertical direction is formed on the front plate 212b for each of the hammers 216w and 216b. The front end of each hammer 216w and the front end of each hammer 216b project forward of the front plate 212b through the opening 212b1. The wall of the lower end of the drive portion 211w1 enters between the leg portions Fw21 and Fw22, while the wall of the lower end of the drive portion 211b1 enters between the leg portions Fb21 and Fb22. Specifically, the leg portions Fw21 and Fb21 enter between the walls of the lower ends of the drive portions 211w1 and 211b1 and intermediate walls that form gaps with the walls of the lower ends in the drive portions 211w1 and 211b1. A shock absorbing member such as rubber, urethane, or felt is fitted and fixed on the wall of the lower end of each of the drive portions 211w1 and 211b1. The shock absorbing member attenuates shock caused by the collision between the lower end of the drive portion 211w1 and the upper surface of the leg portion Fw22, the collision between the lower end of the drive portion 211b1 and the upper surface of the leg portion Fb22, the collision between the lower end of the drive portion 211w1 and the lower surface of the leg portion Fw21, and the collision between the lower end of the drive portion 211b1 and the lower surface of the leg portion Fb21.

The front end of the connection rod 216w2 and the front end of the connection rod 216b2 are assembled to the back end of the base 216w1 and the back end of the base 216b1, respectively. The connection rods 216w2 and 216b2 extend rearward. The position of the back end of the connection rod 216w2 and the position of the back end of the connection rod 216b2 in the longitudinal direction are the same. The mass member 216w3 and the mass member 216b3, described later, are assembled to the back end of the connection rod 216w2 and the back end of the connection rod 216b2, respectively. The mass member 216w3 and the mass member 216b3 correspond to a contact portion of the present invention, and the lower surface of the mass member 216w3 and the lower surface of the mass member 216b3 correspond to a contact surface of the present invention.

The mass member 216w3 and the mass member 216b3 are formed to have a plate-like shape. The mass member 216w3 and the mass member 216b3 are long in the longitudinal direction. The mass member 216w3 and the mass member 216b3 are assembled to the connection rods 216w2 and 216b2 in such a manner that the thickness thereof is along the lateral direction. In the key release state, the lower surface of the mass member 216w3 tilts with respect to the top surface of the frame FR2, and the back side of the lower surface of the mass member 216w3 is located to be higher than the front side. In the key release state, the lower surface of the mass member 216b3 tilts with respect to the top surface of the frame FR2, and the back side of the lower surface of the mass member 216b3 is located to be lower than the front side. In the key depression state, the top surfaces of the mass member 216w3 and the mass member 216b3 are parallel to the lower surface of the top plate 212a of the key frame 212. The appearance of the mass member 216w3 is the same for all hammers 216w. The appearance of the mass member 216b3 is also the same for all hammers 216b.

As described above, the position of the pivot point of the key is different depending upon the assigned pitch. Therefore, the distance from the pivot center of the white key 211w to an engagement portion Pw21 where the leg portion Fw22 and the drive portion 211w1 are engaged with each other (brought into contact with each other) is different depending upon the assigned pitch. The distance from the pivot center of the black key 211b to an engagement portion Pb21 where the leg portion Fb22 and the drive portion 211b1 are engaged with each other (brought into contact with each other) is also different depending upon the assigned pitch. A key depression/release operation position W20 of the white key 211w that is the front end of the position of the white key 211w with the potentiality of being depressed or released is located anterior to the engagement portion Pw21, while a key depression/release operation position B20 of the black key 211b that is the front end of the position of the black key 211b with the potentiality of being depressed or released is located posterior to the engagement portion Pb21. Therefore, if the masses of the mass members for all hammers are equal, a key touch feeling is heavier on the middle-pitched part than on the low-pitched part, and the key touch feeling is heavier on the high-pitched part than on the middle-pitched part, on the key depression/release operation positions W20 and B20, because of the principle of leverage.

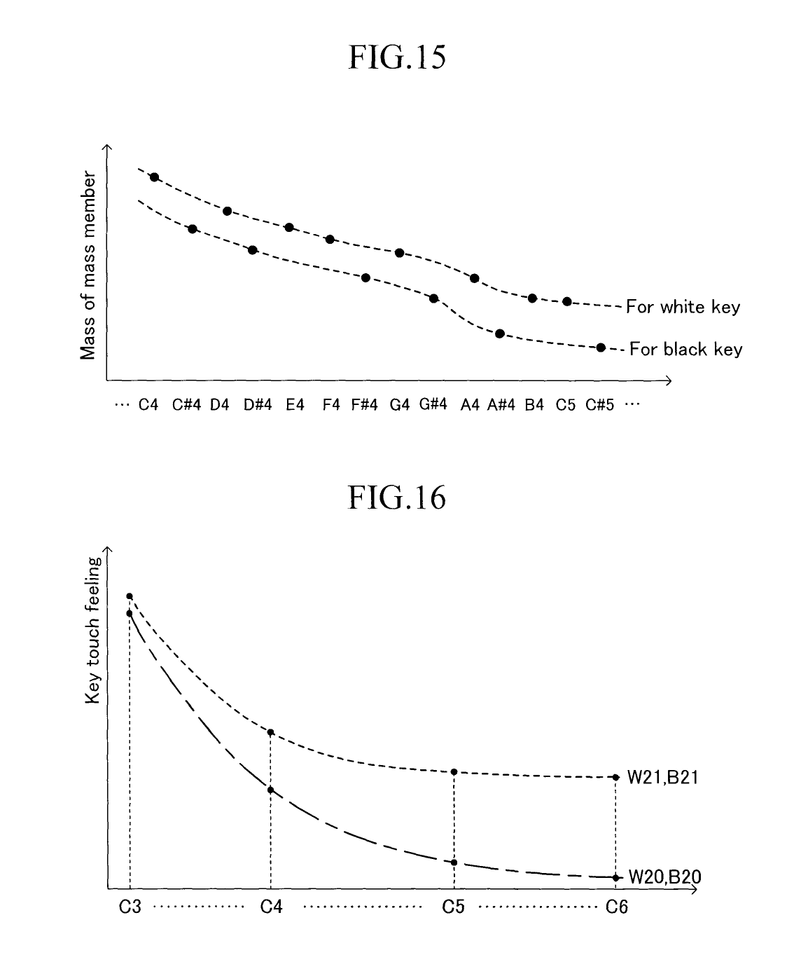

In addition, in this case, the key touch feeling of the white keys 211w and the black keys 211b in each range is not equal. Specifically, the key touch feeling of the black key 211b is heavier than the key touch feeling of the adjacent two white keys 211w. In view of this, the mass of the mass member 216w3 and the mass of the mass member 216b3 are adjusted for each key as illustrated in FIG. 15. Specifically, as illustrated in a characteristic curve indicating the masses of the mass members 216w3 and 216b3 in the order of pitches, the masses of the mass members 216w3 and 216b3 are adjusted such that the characteristic curve of the mass member 216w3 and the characteristic curve of the mass member 216b3 are parallel downward-sloping curves, wherein the characteristic curve of the mass member 216b3 is located below the characteristic curve of the mass member 216w3. Thus, as illustrated by a chain line in FIG. 16, the key touch feeling on the key depression/release operation positions W20 and B20 becomes gradually lighter toward the high-pitched side from the low-pitched side. Therefore, as illustrated by a broken line in FIG. 16, the key touch feeling on key depression/release operation positions W21 and B21 located posterior to the key depression/release operation positions W20 and B20 by a distance d2 also becomes gradually lighter toward the high-pitched side from the low-pitched side. Since the length of the key to which a higher pitch is assigned is shorter, the difference between the key touch feeling on the key depression/release operation positions W20 and B20 and the key touch feeling on the key depression/release operation positions W21 and B21 becomes larger toward the high-pitched side from the low-pitched side. Specifically, the difference in the key touch feeling caused by the longitudinal difference of the key depression/release operation position is small on the low-pitched side, moderate in the middle-pitched side, and large on the high-pitched side.

When the white key 211w and the black key 211b are released, the front ends of the hammers 216w and 216b displace upward due to their own weight of the hammers 216w and 216b. In this case, the drive portion 211w1 and the drive portion 211b1 are biased upward by the leg portion Fw22 and the leg portion Fb22 respectively, whereby the front ends of the white key 211w and the black key 211b displace upward. On the other hand, when the white key 211w and the black key 211b are depressed, the lower surfaces of the drive portion 211w1 and the drive portion 211b1 press the upper surfaces of the leg portion Fw22 and the leg portion Fb22 respectively, whereby the front ends of the hammer 216w and the hammer 216b respectively displace downward.

A lower-limit stopper 220 is provided to the key frame 212. During the key depression, the lower-limit stopper 220 is brought into contact with the upper surfaces of the mass member 216w3 and the mass member 216b3 of the hammer 216w and the hammer 216b so as to restrict the upward displacement of the back ends of the hammer 216w and the hammer 216b, thereby restricting the downward displacement of the front ends of the white key 211w and the black key 211b. The lower-limit stopper 220 includes a stopper rail 220a and a buffer member 220b. The stopper rail 220a protrudes downward from the lower surface at the middle of the top plate 122a. In a planar view of the key frame 212, the stopper rail 220a tilts such that the portion on the high-pitched side is located slightly anterior to the portion on the low-pitched side (see FIG. 10). The stopper rail 220a may extend parallel to the arrangement direction of the keys. The projection amount of the stopper rail 220a from the lower surface of the top plate 212a on the contact portion between the stopper rail 220a and each hammer is constant in the lateral direction. The buffer member 220b is fixed to the lower end surface of the stopper rail 220a. The buffer member 220b is a long member made of a shock-absorbing member such as rubber or felt. The sectional shape of the buffer member 220b is uniform from one end to the other end.

An upper-limit stopper 221 is provided to the middle portion of the frame FR2. During the key release, the upper-limit stopper 221 is brought into contact with the lower surfaces of the mass member 216w1 and the mass member 216b1 of the hammer 216w and the hammer 216b so as to restrict the downward displacement of the back ends of the hammer 216w and the hammer 216b, thereby restricting the upward displacement of the front ends of the white key 211w and the black key 211b. Like the lower-limit stopper 220, the upper-limit stopper 221 includes a stopper rail 221a and a buffer member 221b. Specifically, in a planar view of the key frame 212, the stopper rail 220a tilts such that the portion on the high-pitched side is located slightly anterior to the portion on the low-pitched side (see FIG. 10). The projection amount thereof from the frame FR2 is constant in the lateral direction. The buffer member 221b is fixed on the upper surface of the stopper rail 221a. Like the buffer member 220b, the sectional shape of the buffer member 221b is uniform from one end to the other end. The stopper rail 220a and the stopper rail 221a may continuously extend in the lateral direction, or may discontinuously extend. The stopper rail 220a and the stopper rail 221a may be formed integral with the top plate 212a and the frame FR2 respectively, or may be formed as separate components and assembled to the top plate 212a and the frame FR2 respectively.

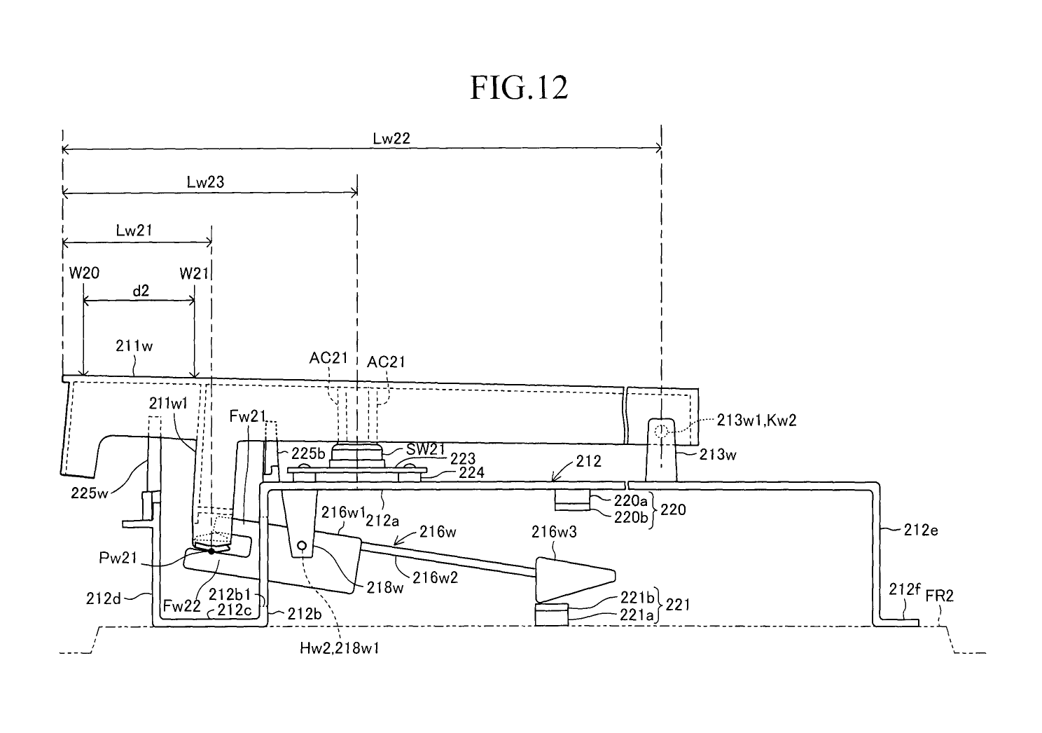

As described above, the stopper rail 221a tilts such that the portion on the low-pitched side is slightly anterior to the portion on the high-pitched side in the planar view of the key frame 212. Therefore, the contact point between the hammer 216w on the high-pitched side (FIG. 12) and the upper-limit stopper 221 is located anterior to the contact point between the hammer 216w (FIG. 11) located on the lower-pitched side from the hammer on the high-pitched side and the upper-limit stopper 221. In the key release state, the rear side of the lower surface of the mass member 216w3 is located to be higher than the front side. Therefore, the back end of the hammer 216w on the high-pitched side in FIG. 12 is located on a position higher than the back end of the hammer 216w on the low-pitched side in FIG. 11. As described above, the top surface of the mass member 216w3 is parallel to the lower surface of the top plate 212a in the key depression state. Specifically, the lower surface of the lower-limit stopper 220 and the top surface of the mass member 216w3 are parallel to each other in a state in which the mass member 216w3 is in contact with the lower surface of the lower-limit stopper 220. Accordingly, in the key depression state, the tilt angle (rocking angle) of the hammer 216w is the same for all hammers 216w. When the tilt angle of the hammer 216w in the key depression state is defined as a reference, the tilt angle of the hammer 216w on the high-pitched side is smaller than the tilt angle of the hammer 216w on the low-pitched side in the key release state. Accordingly, in the key release state, the engagement portion Pw21 between the hammer 216w on the high-pitched side and the drive portion 211w1 is located to be lower than the engagement portion Pw21 between the hammer 216w on the low-pitched side and the drive portion 211w1.

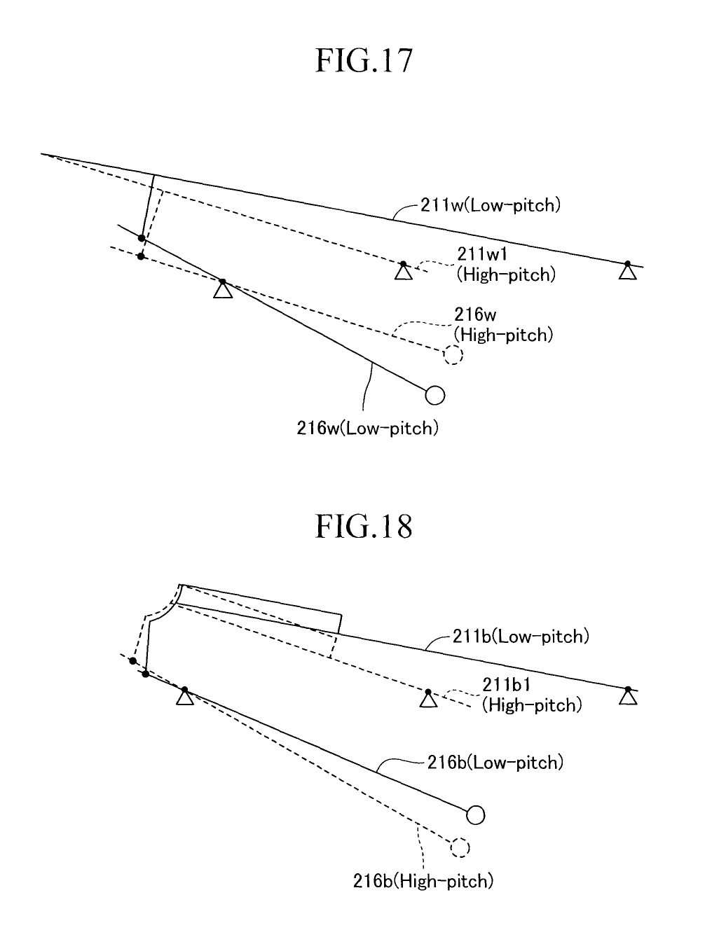

As described above, the white key 211w tilts such that the back end is lower than the front end during the key release. The length of the drive portion 211w1 in the vertical direction is the same for all white keys 211w. The height of the pivot center is the same for all white keys 211w. Accordingly, if the position of the engagement portion Pw21 in the vertical direction is the same during the key release, the front end of the white key 211w having the shorter length in the longitudinal direction might become high. In view of this, in the present embodiment, the position of the upper-limit stopper 221 in the longitudinal direction is set according to the length of the white key 211w in order to set the tilt angle of each hammer 216w in the key release state (see FIG. 17). With this structure, the engagement portion Pw21 of the white key 211w on the high-pitched side is located to be lower than the engagement portion Pw21 of the white key 211w on the low-pitched side, whereby the height of the front ends of all white keys 211w is adjusted to be the same.

The contact point between the hammer 216b on the high-pitched side (FIG. 14) and the upper-limit stopper 221 is located forward than the contact point between the hammer 216b on the low-pitched side from the hammer on the high-pitched side (FIG. 13) and the upper-limit stopper 221. In the key release state, the rear side on the lower surface of the mass member 216b3 is located to be lower than the front side. Therefore, the rear end of the hammer 216b on the high-pitched side in FIG. 14 is located to be lower than the rear end of the hammer 216b on the low-pitched side in FIG. 13. As described above, the top surface of the mass member 216b3 is parallel to the lower surface of the top plate 212a in the key depression state. Specifically, in the state in which the mass member 216b3 is in contact with the lower surface of the lower-limit stopper 220, the lower surface of the lower-limit stopper 220 and the top surface of the mass member 216b3 are parallel to each other. Accordingly, in the key depression state, the tilt angle (rocking angle) of the hammer 216b is the same for all hammers 216b. When the tilt angle of the hammer 216b in the key depression state is defined as a reference, the tilt angle of the hammer 216b on the high-pitched side is larger than the tilt angle of the hammer 216b on the low-pitched side in the key release state. Consequently, in the key release state, the engagement portion Pb21 between the hammer 216b on the high-pitched side and the drive portion 211b1 is located to be higher than the engagement portion Pb21 between the hammer 216b on the high-pitched side and the drive portion 211b1.

As described above, the black key 211b tilts such that the back end is lower than the front end during the key release. The length of the drive portion 211b1 in the vertical direction is the same for all black keys 211b. The height of the pivot center is the same for all black keys 211b. Accordingly, if the position of the engagement portion Pb21 in the vertical direction is the same during the key release, the front end of the black key 211b having the shorter length in the longitudinal direction might become low. In view of this, in the present embodiment, the position of the upper-limit stopper 221 in the longitudinal direction is set according to the length of the black key 211b in order to set the tilt angle of each hammer 216b in the key release state (see FIG. 18). With this structure, the engagement portion Pb21 of the black key 211b on the high-pitched side is located to be higher than the engagement portion Pb21 of the black key 211b on the low-pitched side, whereby the height of the front ends of all black keys 211b is adjusted to be the same.

In a state in which two adjacent white keys 211w and the black key 211b between the two adjacent white keys 211w are released, the rocking angle of each hammer is set such that the edge line R2 of the black key 211b is located below the top face of one on the low-pitched side of the two white keys 211w, and above the top face of one on the high-pitched side of the two white keys 211w.

The rocking angle of each hammer is set such that, in the state in which the white key 211w and the black key 211b adjacent to the white key 211w are depressed respectively by the same depression force, and their rocking movement is restricted, the edge line R2 of the black key 211b is located below the top face of the white key 211w. The buffer member 220b and the buffer member 221b have elasticity. Therefore, when the key is depressed more after the hammer is brought into contact with the buffer member during the key depression, the buffer member is elastically deformed, so that the front end of the key slightly displaces downward.

A switch drive portion AC21 is provided on the lower surface of each of the white key 211w and the black key 211b on the middle part. The switch drive portion AC21 is a plate-like member extending in the vertical direction in each of the white key 211w and the black key 211b, and the lower end surface of the switch drive portion AC21 is brought into contact with the upper surface of a switch SW21. The switch SW21 is provided for each key. The switch SW21 is pressed by the corresponding key to detect whether the corresponding key is depressed or released. Specifically, when the switch SW21 is depressed by the key, a rubber main body is deformed to make two contacts, which are formed on a circuit board 223, short-circuit, thereby being turned ON. The circuit board 223 extends in the lateral direction. Through-holes penetrating from the upper surface to the lower surface are formed on the circuit board 223. The through-holes correspond to a bosses 224 formed integral with the upper surface of the top plate 212a. When screws are threaded to the bosses 224 through the through-holes, the circuit board 223 is fixed to the key frame 212. The main bodies of the plural switches SW21, each corresponding to each key, are arranged on the upper surface of the circuit board 223 in the lateral direction. The position of the switch SW21 for the white key 211w and the position of the switch SW21 for the black key 211b in the longitudinal direction are the same. A distance Lw23 from the front end of the white key 211w to the switch SW21 in the longitudinal direction is within 30% of the distance Lw22 from the front end of the white key 211w with the highest pitch to the through-hole Kw2, and a distance Lb23 from the front end of the apparent portion of the black key 211b to the switch SW21 is within 30% of the distance Lb22 from the front end of the apparent portion of the black key 211b with the highest pitch to the through-hole Kb2. The switch SW21 for the white key 211w and the switch SW21 for the black key 211b may be arranged side by side in the lateral direction, and the positions of both switches in the longitudinal direction may be shifted.

A key guide 225w for guiding the rocking movement of the white key 211w is formed to project upward from the top end surface of the front plate 212d. The key guide 225w is inserted into the white key 211w from below, and during the key depression and key release, the side face of the key guide 125w and the inside face of the sidewall of the white key 211w are in sliding contact with each other. This structure can prevent a slight displacement of the white key 211w in the lateral direction during the key depression and key release.

A key guide 225b for guiding the rocking movement of the black key 211b is formed to project upward from the upper surface of the top plate 212a at the front end. The key guide 225b is inserted into the black key 211b from below, and during the key depression and key release, the side face of the key guide 225b and the inside face of the sidewall of the black key 211b are in sliding contact with each other. This structure can prevent a slight displacement of the black key 211b in the lateral direction during the key depression and key release.

In the keyboard device having the configuration described above, the height of the front ends of the keys during the key release is adjusted to be the same, whereby the appearance of the key board device can be made similar to the appearance of the keyboard device for an acoustic piano during the key release. In addition, the keyboard device according to the present embodiment has high productivity, compared to the keyboard device for an acoustic piano in which the height of the front ends of the keys is adjusted to be the same by adjusting the number or the thickness of the spacer, which is sandwiched between the key support portion and the frame.

The distance from the top face of the apparent portion of the white key 221w to the pivot center is the same for all white keys 221w, and the distance from the top face of the body of the black key 221b to the pivot center is the same for all black keys 221b. Accordingly, when the through-holes Kw2 and Kb2 are formed in a different process after a process of molding the outer shape of the white key 221w and the black key 221b, the different process can commonly be carried out for all keys to enhance productivity of the keys. The positions of the projections 213w1 and 213b1 of the key support portions 213w and 213b in the vertical direction are set to be the same for all key support portions 213w and 213b, resulting in that the frame 212 that supports the keys is easily designed. In addition, the frame 212 is easily processed, and the precision can be enhanced.

In the planar view, the upper-limit stopper 221 is arranged to tilt, and the tilting direction of the lower surface of the mass member 216w3 and the tilting direction of the lower surface of the mass member 216b3 are set to be reverse to each other. With this structure, as for the hammers 216w for the white keys 211w, the tilt angle in the key release state becomes gradually small from the hammer 216w on the low-pitched side toward the hammer 216w on the high-pitched side. As for the hammers 216b for the black keys 211b, the tilt angle in the key release state becomes gradually large from the hammer 216b on the low-pitched side toward the hammer 216b on the high-pitched side. Accordingly, there is no need to provide the upper-limit stopper 221 for each hammer, whereby the number of components can be reduced, and the cost for the keyboard device can be reduced. In addition, the productivity of the keyboard device can be enhanced.

Upon embodying the present invention, the present invention is not limited to the above-described embodiment, and various modifications are possible without departing from the scope of the present invention.

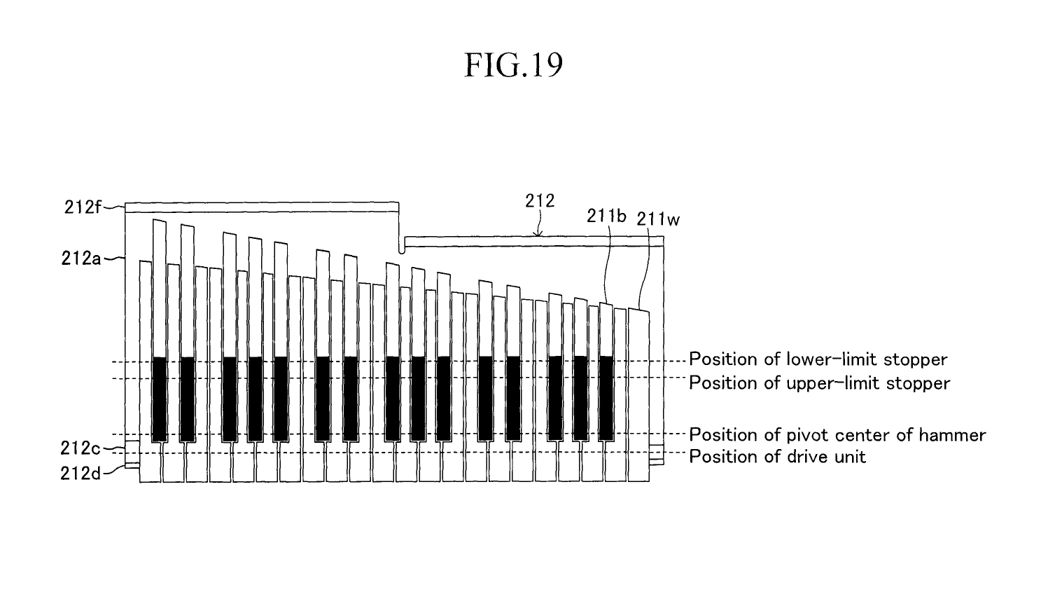

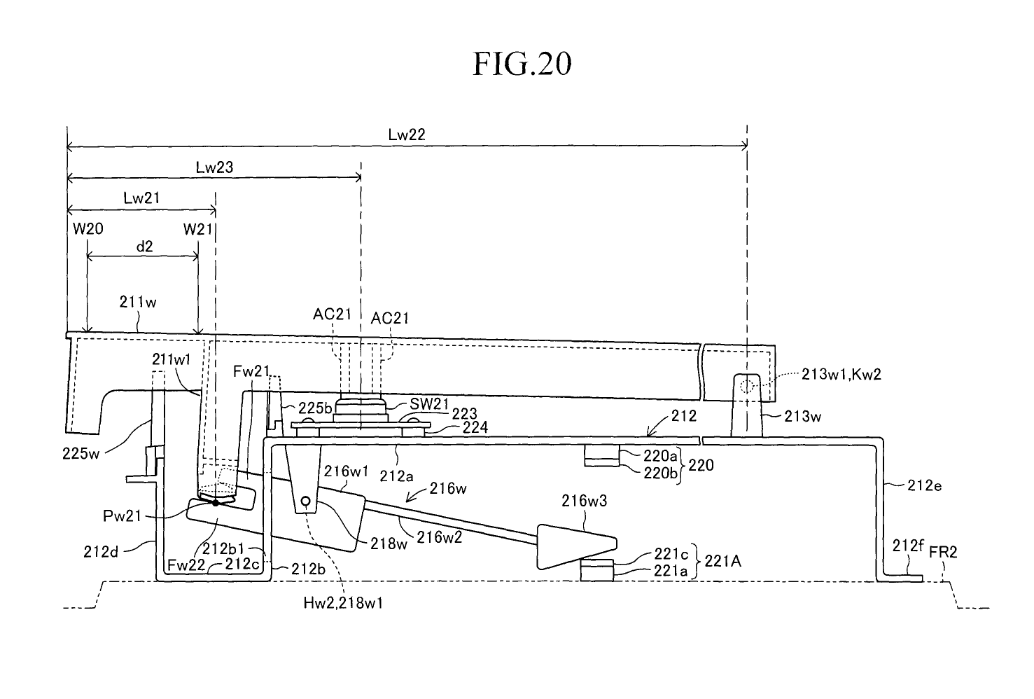

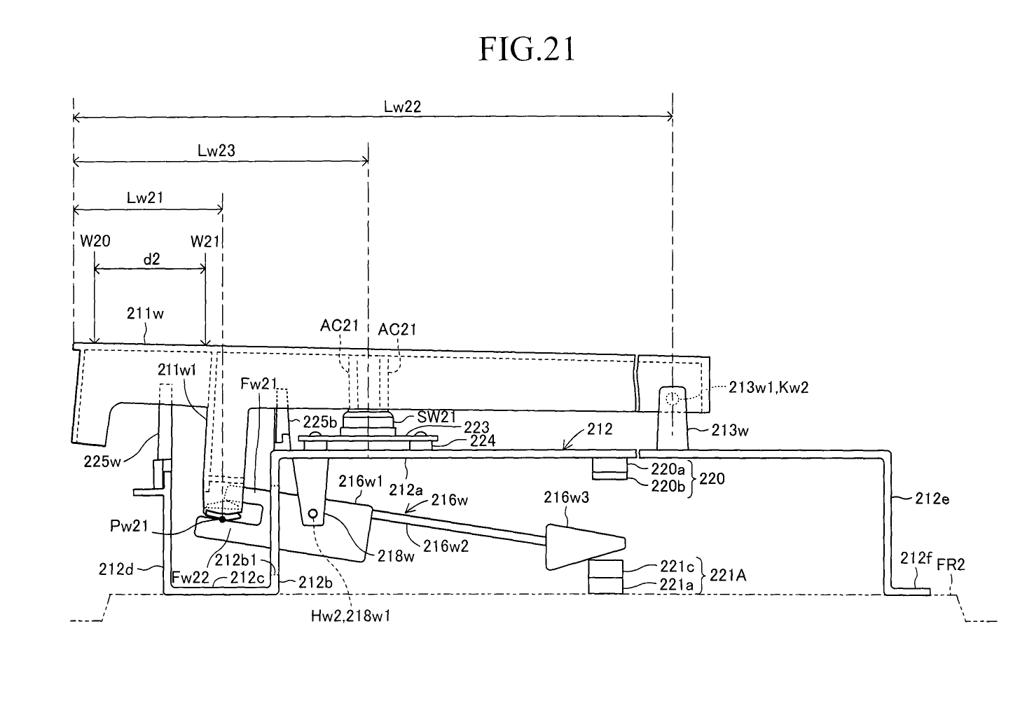

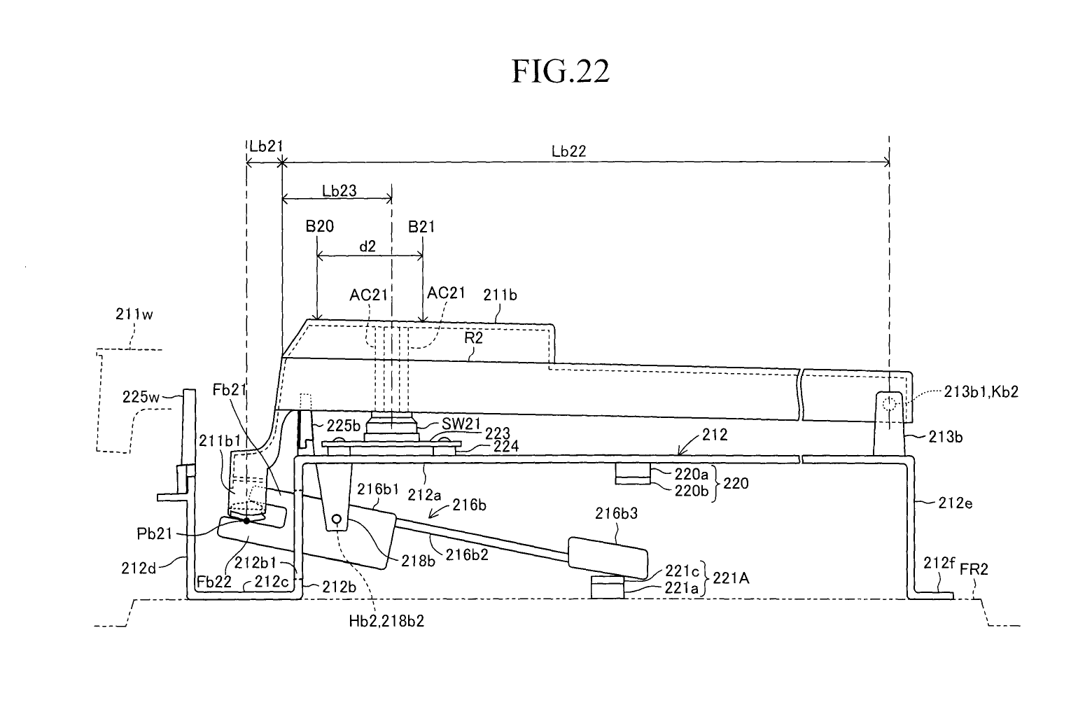

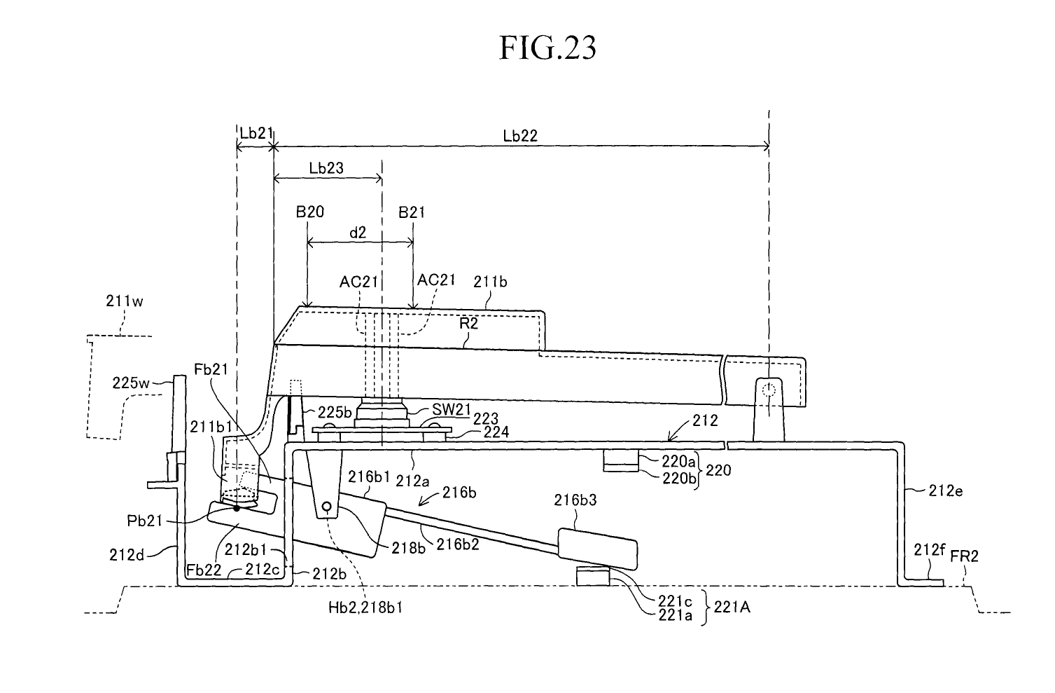

In the present embodiment, the upper-limit stopper 221 tilts such that the portion on the high-pitched side is located to be forward from the portion on the low-pitched side in the planar view of the key frame 212. However, instead of this structure, an upper-limit stopper 221A may extend parallel to the arrangement direction of the keys as illustrated in FIGS. 19 to 23. In this case, a buffer member 221c is used instead of the buffer member 221b. The thickness of the buffer member 221c in the vertical direction is different for each hammer. Specifically, the buffer member 221c of the hammer 216w for the white key 221w (FIG. 20) on the low-pitched side is thin, while the buffer member 221c of the hammer 216w for the white key 221w on the high pitched side is thicker than the low-pitched side. As described above, the tilt angle of each hammer in the key release state may be set by setting the thickness of the buffer member 221c according to the length of the white key 221w. Even with this structure, the height of the front ends of the white keys 211w in the key release state can be adjusted to be the same. The buffer member 221c for the black key 211b (FIG. 22) on the low-pitched side is thick, while the buffer member 221c for the black key 221b (FIG. 23) on the high-pitched side is thinner than the low-pitched side. As described above, the tilt angle of each hammer in the key release state may be set by setting the thickness of the buffer member 221b according to the length of the black key 221b. Even with this structure, the height of the front ends of the black keys 211b in the key release state can be adjusted to be the same.

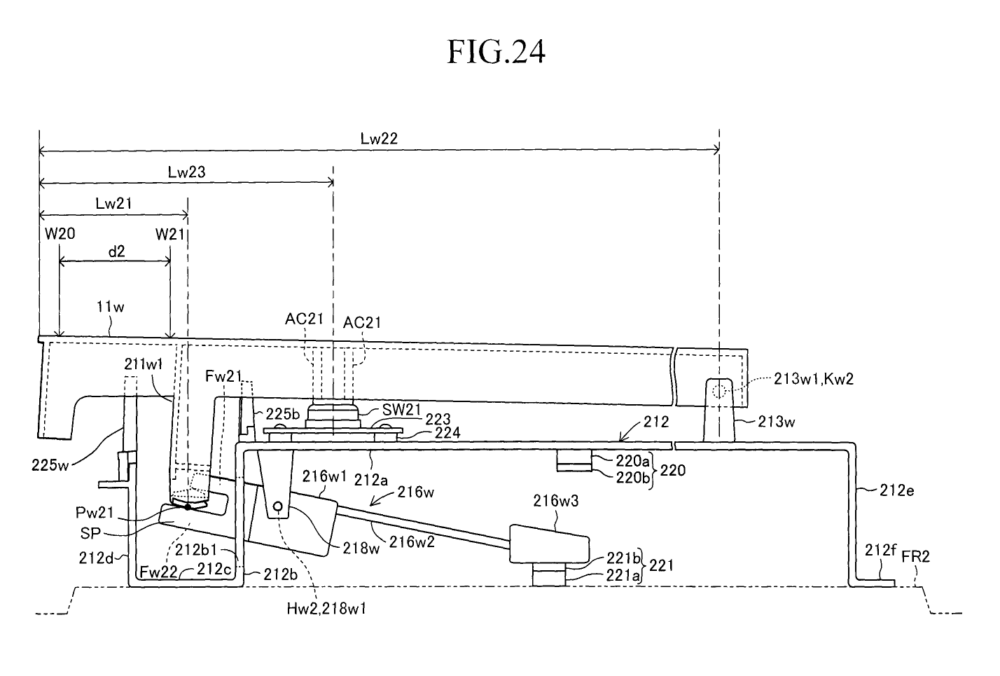

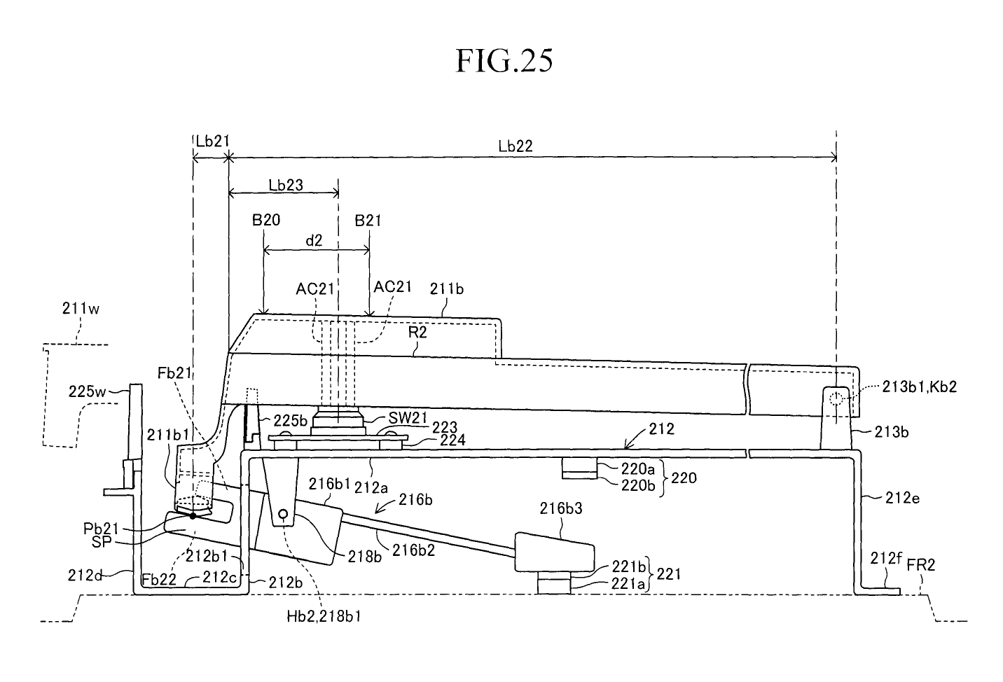

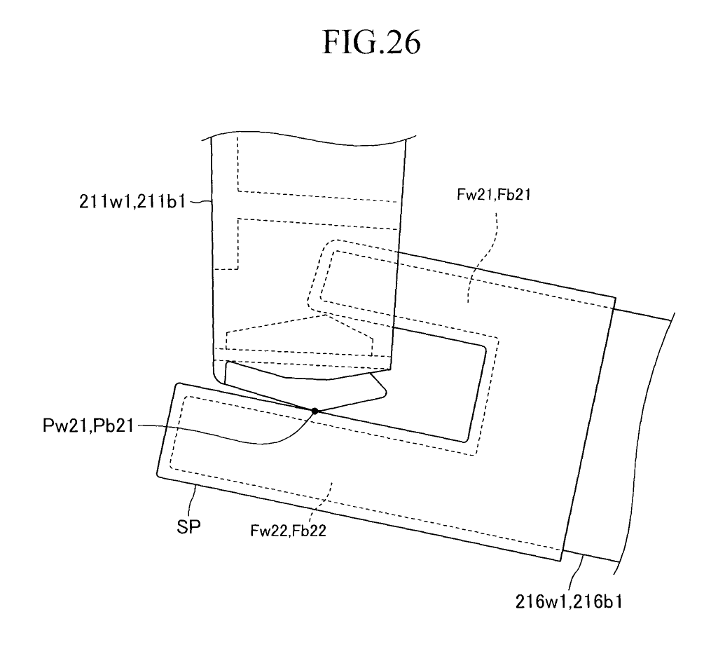

As illustrated in FIGS. 24 and 25, the lower surface of the mass member 216w3 and the lower surface of the mass member 216b3 may be parallel to the top surface of the frame FR2 in the key release state. In this case, the thickness of the buffer member 221b is the same for all hammers. Therefore, the tilt angles of the hammer 216w and the hammer 216b in the key release state are the same, regardless of the assigned pitch. In view of this, as illustrated in FIG. 26, a spacer SP having a thickness according to the length of each key is provided on the leg portions Fw21 and Fw22 of the hammer 216w and the leg portions Fb21 and Fb22 of the hammer 216b. Specifically, the spacer SP for the hammer 216w on the high-pitched side is set to be thin, and the spacer SP for the hammer 216w on the low-pitched side is set to be thicker than the high-pitched side, whereby the engagement portion Pw21 of the white key 211w on the high-pitched side is located to be lower than the engagement portion Pw21 of the white key 211w on the low-pitched side. Thus, the height of the front end of the white key 211w can be adjusted to be the same. The spacer SP for the hammer 216b on the high-pitched side is set to be thick, and the spacer SP for the hammer 216b on the low-pitched side is set to be thinner than the high-pitched side, whereby the engagement portion Pb21 of the black key 211b on the high-pitched side is located to be higher than the engagement portion Pb21 of the black key 211b on the low-pitched side. Thus, the height of the front end of the black key 211b can be adjusted to be the same. The thickness of the shock absorbing member fitted to the lower end wall of the drive portion 211w1 and the drive portion 211b1 is adjusted according to the thickness of the spacer SP.

In the keyboard device illustrated in FIGS. 24 and 25, the height of the engagement portion Pw21 and the engagement portion Pb21 may be adjusted by bending the connection rod 216w2 of the hammer 216w and the connection rod 216b2 of the hammer 216b on the middle portion in the longitudinal direction, not by mounting the spacer illustrated in FIG. 26. For example, the connection rod may be bent such that the back end of the hammer 216w is lifted upward, and the back end of the hammer 216b is pushed downward. The bending amount (bending angle) of the connection rod may be set according to the length of the engaged key. In this case, the engagement portion Pw21 of the white key 211w on the high-pitched side is located to be lower than the engagement portion Pw21 of the white key 211w on the low-pitched side by the structure in which the bending amount of the connection rod 216w2 of the hammer 216w on the low-pitched side increases, and the bending amount of the connection rod 216w2 of the hammer 216w on the high-pitched side decreases. With this structure, the height of the front ends of the white keys 211w in the key release state can be adjusted to be the same. The engagement portion Pb21 of the black key 211b on the low-pitched side is located to be lower than the engagement portion Pb21 of the black key 211b on the high-pitched side by the structure in which the bending amount of the connection rod 216b2 of the hammer 216b on the low-pitched side increases, and the bending amount of the connection rod 216b2 of the hammer 216b on the high-pitched side decreases. With this structure, the height of the front ends of the black keys 211b in the key release state can be adjusted to be the same.

In the embodiment described above, the white key 211w and the black key 211b are supported by the key support portions 213w and 213b of the key frame 212 by fitting the projections 213w1 and 213b1 to the through-holes Kw and Kb respectively so that the front ends of the white key 211w and the black key 211b can rock in the vertical direction. However, the white key 211w and the black key 211b can be mounted on the key frame 212 by using various supporting mechanisms, if the white key 211w and the black key 211b are supported by the key frame 212 so that the front ends of the white key 211w and the black key 211b can rock in vertical direction. For example, the rear ends of plural keys (the white key 211w and/or the black key 211b) may be are supported by the key frame 212 through elastic deformation members so that the front ends of the plural keys can rock in vertical direction. Concretely, the rear ends of the plural keys are connected to a fixing member fixed to the key frame 212 through thin and elastic connection members, wherein the fixing member is extended in the lateral direction, the connection members are extended horizontally or vertically, and the plural keys, the connection members and the fixing member are formed integrally. In this case, for example, the connection members for the white keys 211w are extended horizontally, and the connection members for the black keys 111b are extended vertically.

Subsequently, a third embodiment of the present invention will be described below with reference to the drawings. In the description below, a side close to a performer is defined as a “front side”, while a side far from the performer is defined as a “rear side”. A high-pitched side is defined as a “right side”, while a low-pitched side is defined as a “left side”.

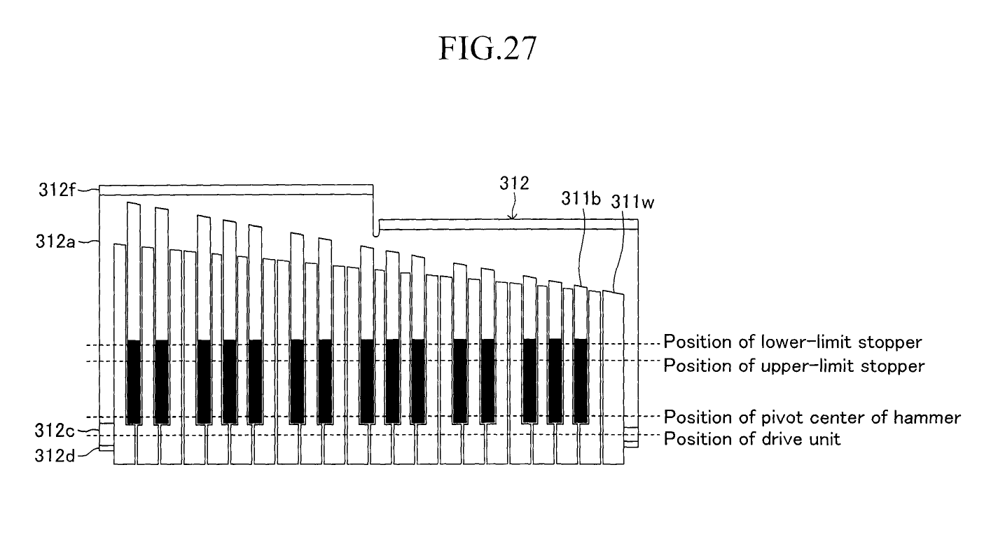

A keyboard device includes plural white keys 311w and plural black keys 311b as illustrated in FIG. 27. A different pitch is assigned to each of plural white keys 311w and each of plural black keys 311b. In the present embodiment, one of “C3”, “D3”, . . . “C6” is assigned to the white keys 311w, while one of “C#3”, “D#3”, “B#5” is assigned to the black keys 311b. The white keys 311w and black keys 311b are integrally formed to have a long shape by a synthetic resin. The white keys 311w are configured such that the length thereof is gradually shorter toward the white key 311w on the high-pitched side from the white key 311w on the low-pitched side. The black keys 311b are configured such that the length thereof is gradually shorter toward the black key 311b on the high-pitched side from the black key 311b on the low-pitched side. The back end of the black key 311b is located posterior to the back end of the adjacent white key 311w.

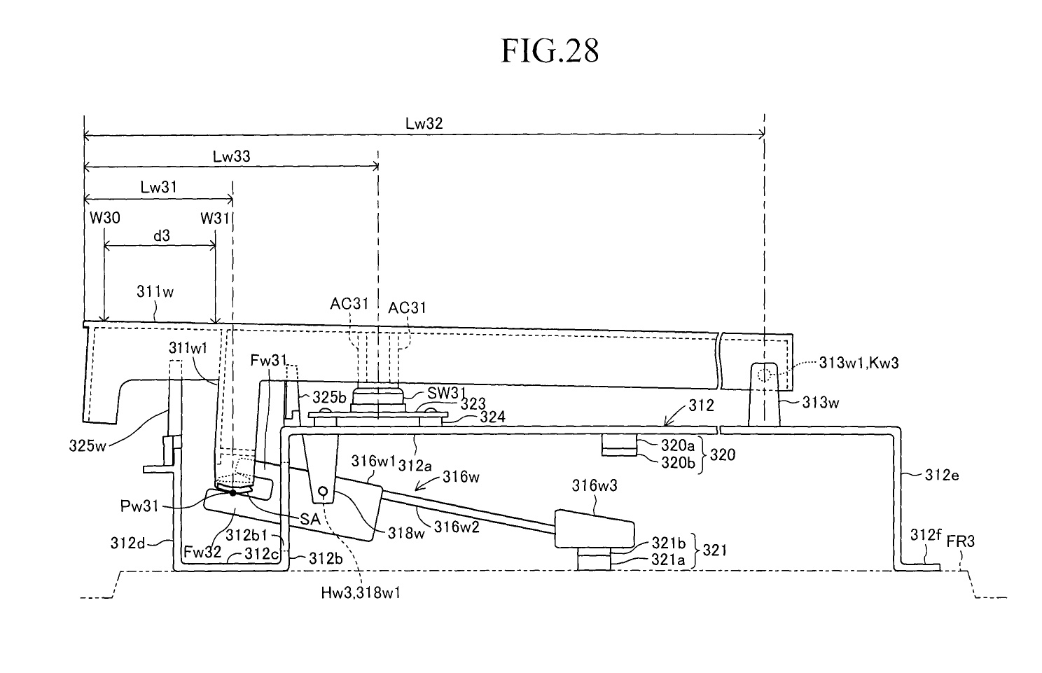

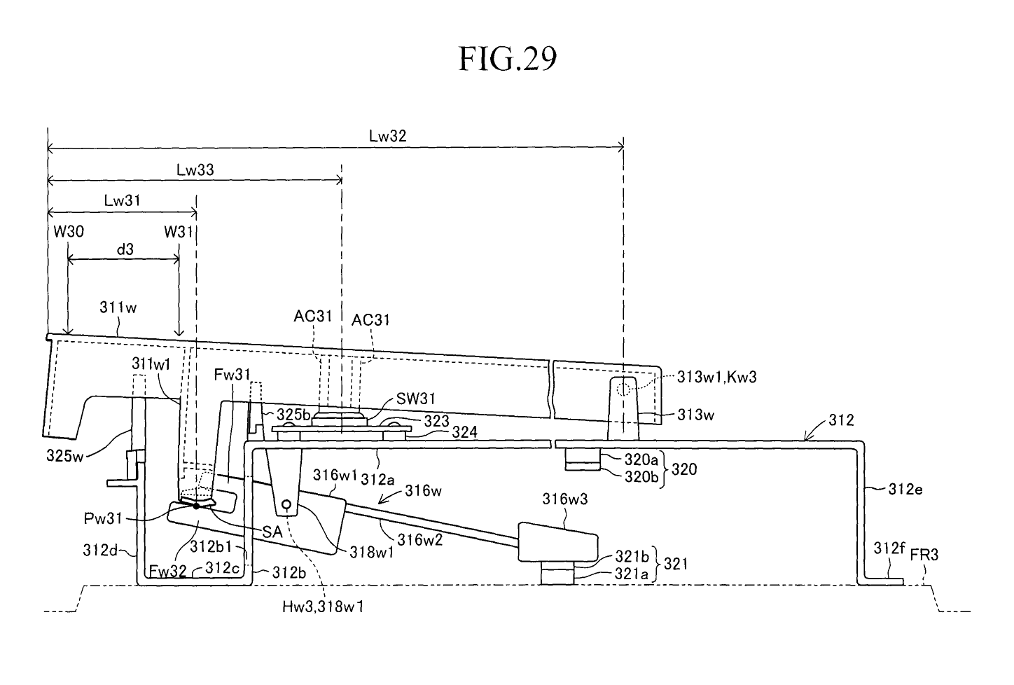

As illustrated in FIGS. 28 to 31, each of the white keys 311w has a width in the vertical direction smaller than that of the black key 311b, and has a width in the lateral direction larger than that of the black key 311b. The white key 311w and the black key 311b have a hollow shape including a thin top wall extending in the longitudinal direction, and thin sidewalls extending downward from left and right ends of the top wall respectively, with no bottom.

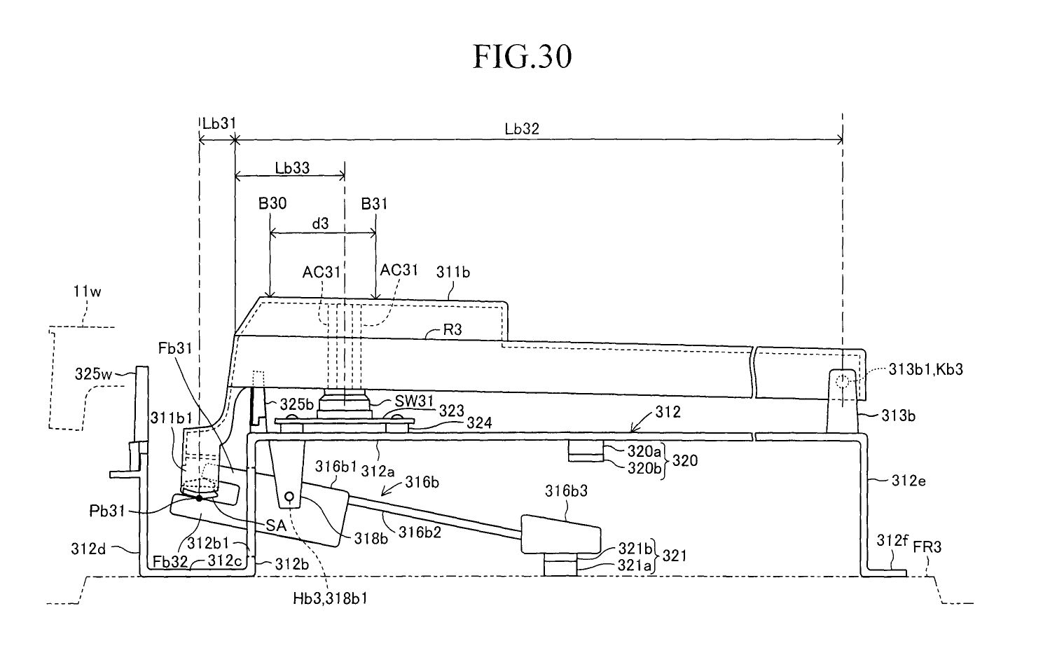

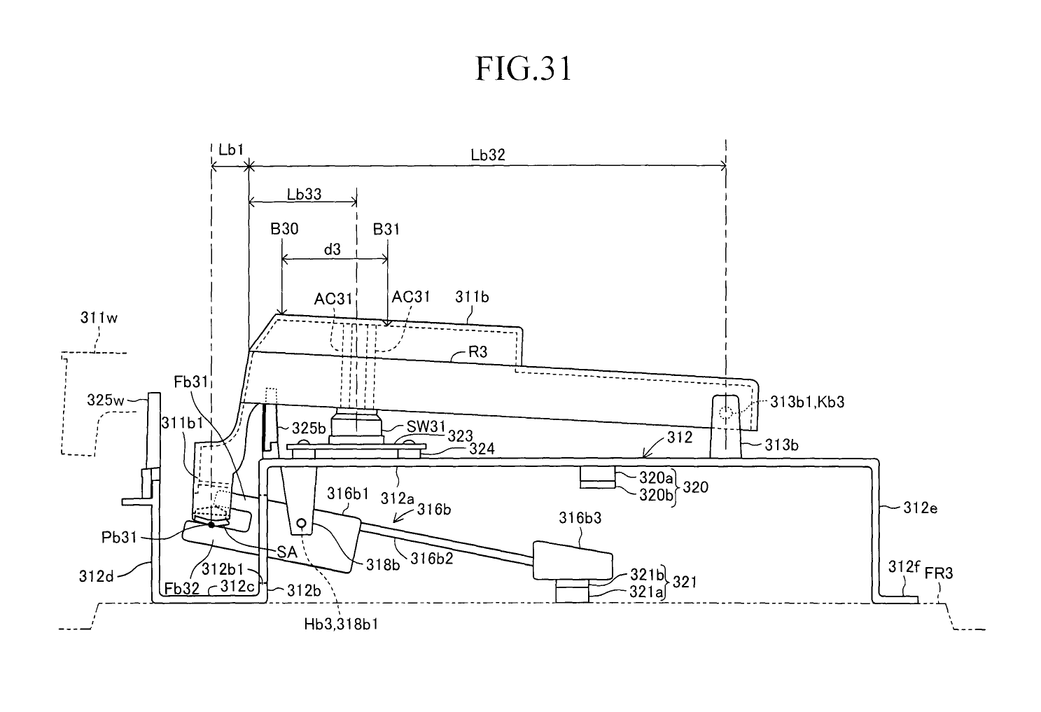

Through-holes Kw3 and Kb3 that are opposite to each other are formed on the rear part of the sidewall of the white key 311w and the black key 311b. The distance from the through-holes Kw3 and Kb3 to the back end of each key is the same for all keys. The white key 311w and the black key 311b are supported by a key support portion 313w and a key support portion 313b of a later-described key frame 312 with the through-holes Kw3 and Kb3. In the key release state, the white key 311w and the black key 311 tilt such that the back end becomes lower than the front end. The back end of the white key 311w goes into a casing of the electronic musical instrument, when the keyboard device is assembled to the electronic musical instrument. The portion of the white key anterior to the portion going into the casing is referred to as an apparent portion of the white key 311w. An edge line is formed on the portion where the side face and the top face of the white key 311w cross each other. The black key 311b has a portion projecting upward from the top face of the white key 311w in a state in which the black key 311b is not depressed, and the adjacent white keys 311w are not depressed. The projecting portion is referred to as an apparent portion of the black key 311b. The portion lower than the apparent portion of the black key 311b is referred to as a body. A performer depresses or releases the apparent portions of the white key 311w and the black key 311b. Specifically, the apparent portion corresponds to an operation portion in the present invention. The width of the apparent portion of the black key 311b in the lateral direction becomes narrower toward the top end, and the width of the body in the lateral direction is the same. Specifically, the side face of the apparent portion tilts inward with respect to the side face of the body. An edge line R3 is formed on the boundary between the apparent portion of the black key 311b and the body (see FIGS. 30 and 31).

The key frame 312 has a top plate 312a extending in the longitudinal direction and lateral direction. The position of the front end of the top plate 312a at the low-pitched side and the position of the front end at the high-pitched side are the same, but the back end at the low-pitched side is located posterior to the back end at the high-pitched side. The key frame 312 also has a front plate 312b vertically extending downward from the front end of the top plate 312a, a bottom plate 312c horizontally extending from the lower end of the front plate 312b, and a front plate 312d vertically extending upward from the front end of the bottom plate 312c. The key frame 312 also includes a rear plate 312e vertically extending downward from the back end of the top plate 312a, and a bottom plate 312f horizontally extending rearward from the lower end of the rear plate 312e. The height of the lower surface of the bottom plate 312c and the height of the lower surface of the bottom plate 312f are the same. The keyboard device is supported by a frame FR3 of an electronic musical instrument by the structure in which the lower surface of the bottom plate 312c and the lower surface of the bottom plate 312f are brought into contact with the frame FR3 of the electronic musical instrument and fixed thereto. The above-described key support portion 313w and the key support portion 313b are formed to project upward from the upper surface of the top plate 312a. The key support portion 313b is located posterior to the adjacent key support portion 313w. The key support portion 313w and the key support portion 313b respectively include two opposing plates, and a projection 313w1 and projection 313b1 that project inward. The projections 313w1 and 313b1 are fitted to the through-holes Kw3 and Kb3 respectively. Therefore, the white key 311w and the black key 311b are supported to be rotatable about the projections 313w1 and 313b1, and their front ends can rock in the vertical direction with the through-holes Kw3 and Kb3 and the center axes of the projections 313w1 and the projections 313b1 being defined as a pivot center. The position of the projection 313w1 and the position of the projection 313b1 in the vertical direction are the same for all key support portions. Specifically, the height of the pivot center is the same for all keys. The distance between the top face of the apparent portion of the white key 311w (i.e., the plane including the right and left edge lines of the white key 311w) and its pivot center in the vertical direction is the same for all white keys 311w. The distance between the top face of the operation portion of the black key 311b (i.e., the plane including the right and left edge lines R3 of the black key 311b) and its pivot center in the vertical direction is the same for all black keys 311b.

A drive portion 311w1 extends downward from the middle portion of the apparent portion of the white key 311w. The drive portion 311w1 has a hollow shape including a thin front wall extending in the vertical direction, and thin sidewalls extending rearward from left and right ends of the front wall, with no rear wall. The lower end of the drive portion 311w1 is closed by a lower end wall. The length of the drive portion 311w1 in the vertical direction is different according to the assigned pitch. The length of the drive portion 311w1 in the vertical direction will be described later. On the other hand, the black key 311b also has a drive portion 311b1 same as the drive portion 311w1 of the white key 311w. The drive portion 311b1 has a connection portion that extends downward from the front end of the apparent portion of the black key 311b and that is slightly curved to the front, and a vertical portion projecting downward from the leading end of the connection portion. The configuration of the vertical portion is the same for the drive portion 311w1. The length of the drive portion 311b1 in the vertical direction is different according to the assigned pitch. The length of the drive portion 311b1 in the vertical direction will be described later.

A distance Lw31 from the front end of the white key 311w to the drive portion 311w1 in the longitudinal direction is within 30% of a distance Lw32 from the front end of the white key 311w with the highest pitch (i.e., the shortest key of the plural white keys 311w) to the through-hole Kw3. The distance Lw31 is the same for all white keys 311w. A distance Lb31 from the front end of the apparent portion of the black key 311b to the drive portion 311b1 in the longitudinal direction is within 30% of a distance Lb32 from the front end of the apparent portion of the black key 311b with the highest pitch (e.g., the shortest key of the plural black keys 311b) to the through-hole Kb3. The distance Lb31 is the same for all black keys 311b. The position of the drive portion 311w1 and the position of the drive portion 311b1 in the longitudinal direction in the key-released state of the white key 311w and the black key 311b are the same. Specifically, the drive portions 311w1 and the drive portions 311b1 are located anterior to the front end of the apparent portion of the black keys 311b, and the drive portions 311w1 and the drive portions 311b1 are arranged in the lateral direction.

The lower ends of the drive portion 311w1 and the drive portion 311b1 are respectively engaged with front ends of hammers 316w and 316b in the opening formed between the front plate 312b and the front plate 312d. As described in detail later, the hammer 316w and the hammer 316b rock with the rocking movement of the corresponding white key 311w and the black key 311b with which the respective hammers 316w and 316b are engaged.

The hammer 316w includes a base 316w1 made of synthetic resin, a connection rod 316w2 made of metal, and a mass member 316w3. Like the hammer 316w, the hammer 316b includes a base 316b1, a connection rod 316b2, and a mass member 316b3. The base 316w1 and the base 316b1 are plate-like members, and formed with through-holes Hw3 and Hb3, respectively, from the right side face to the left side face. A hammer support portion 318w and a hammer support portion 318b are formed to project downward from the lower surface of the top plate 312a. The hammer support portions 318w and 318b are formed to have two opposing plates, and respectively have projections 318w1 and 318b1 projecting inward. The projections 318w1 and 318b1 are respectively fitted to the through-holes Hw3 and Hb3. With this structure, the bases 316w1 and 316b1 are supported to be rotatable about the projections 318w1 and 318b1. Specifically, the hammer 316w and the hammer 316b are supported such that the front ends and the back ends can be rocked in the vertical direction. The positions of the hammer support portion 318w and the hammer support portion 318b in the longitudinal direction and in the vertical direction are the same for all hammer support portions 318w and 318b. Specifically, plural hammer support portions 318w and the plural hammer support portions 318b are arranged side by side in the lateral direction, and the positions of the pivot centers of all hammers 316w and hammers 316b in the longitudinal direction and in the vertical direction are the same for all hammers 316w and 316b. In other words, the pivot centers of the hammers 316w and the hammers 316b are located on the same straight line extending in the lateral direction.

The base 316w1 includes a pair of leg portion Fw31 and leg portion Fw32 on its front end. The upper leg portion Fw31 is formed to be shorter than the lower leg portion Fw32. Like the base 316w1, the base 316b1 includes a pair of leg portion Fb31 and leg portion Fb32 on its front end. An elongated slit-like opening 312b1 extending in the vertical direction is formed on the front plate 312b for each of the hammers 316w and 316b. The front end of each hammer 316w and the front end of each hammer 316b project forward of the front plate 312b through the opening 312b1. The wall of the lower end of the drive portion 311w1 enters between the leg portions Fw31 and Fw32, while the wall of the lower end of the drive portion 311b1 enters between the leg portions Fb31 and Fb32. Specifically, the leg portions Fw31 and Fb31 enter between the walls of the lower ends of the drive portions 311w1 and 311b1 and intermediate walls that form gaps with the walls of the lower ends in the drive portions 311w1 and 311b1. A shock absorbing member SA such as rubber, urethane, or felt is fitted and fixed on the wall of the lower end of each of the drive portions 311w1 and 311b1. The shock absorbing member SA attenuates shock caused by the collision between the lower end of the drive portion 311w1 and the upper surface of the leg portion Fw32, the collision between the lower end of the drive portion 311b1 and the upper surface of the leg portion Fb32, the collision between the lower end of the drive portion 311w1 and the lower surface of the leg portion Fw31, and the collision between the lower end of the drive portion 311b1 and the lower surface of the leg portion Fb31.

The front end of the connection rod 316w2 and the front end of the connection rod 316b2 are assembled to the back end of the base 316w1 and the back end of the base 316b1, respectively. The connection rods 316w2 and 316b2 extend rearward. The position of the back end of the connection rod 316w2 and the position of the back end of the connection rod 316b2 in the longitudinal direction are the same. The mass member 316w3 and the mass member 316b3, described later, are assembled to the back end of the connection rod 316w2 and the back end of the connection rod 316b2, respectively.

The mass member 316w3 and the mass member 316b3 are formed to have a plate-like shape. The mass member 316w3 and the mass member 316b3 are long in the longitudinal direction. The mass member 316w3 and the mass member 316b3 are assembled to the connection rods 316w2 and 316b2 in such a manner that the thickness thereof is along the lateral direction.

As described above, the position of the pivot point of the key is different depending upon the assigned pitch. Therefore, the distance from the pivot center of the white key 311w to an engagement portion Pw31 where the leg portion Fw32 and the drive portion 311w1 are engaged with each other (brought into contact with each other) is different depending upon the assigned pitch. The distance from the pivot center of the black key 311b to an engagement portion Pb31 where the leg portion Fb32 and the drive portion 311b1 are engaged with each other (brought into contact with each other) is also different depending upon the assigned pitch. A key depression/release operation position W30 of the white key 311w that is the front end of the position of the white key 311w with the potentiality of being depressed or released is located anterior to the engagement portion Pw31, while a key depression/release operation position B30 of the black key 311b that is the front end of the position of the black key 311b with the potentiality of being depressed or released is located posterior to the engagement portion Pb31. Therefore, if the masses of the mass members for all hammers are equal, a key touch feeling is heavier on the middle-pitched part than on the low-pitched part, and the key touch feeling is heavier on the high-pitched part than on the middle-pitched part, on the key depression/release operation positions W30 and B30, because of the principle of leverage.

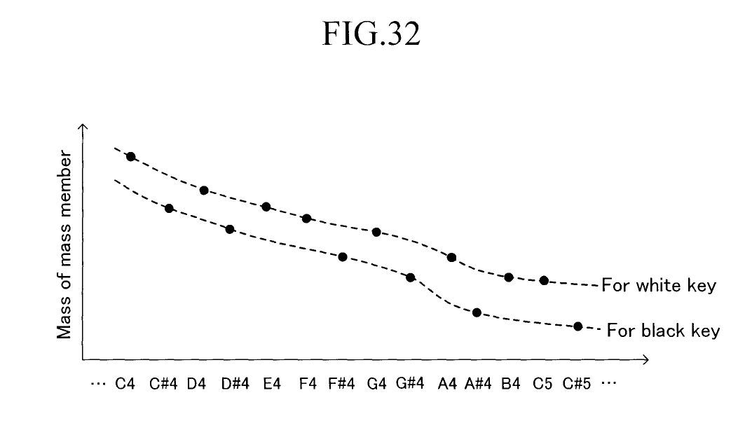

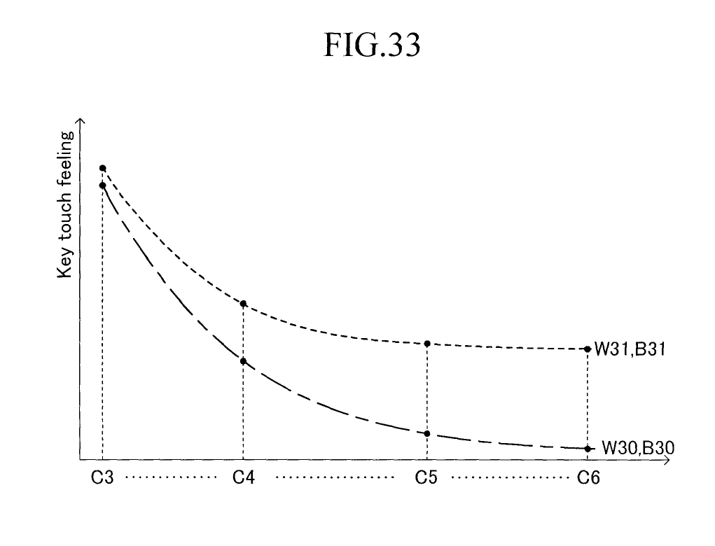

In addition, in this case, the key touch feeling of the white keys 311w and the black keys 311b in each range is not equal. Specifically, the key touch feeling of the black key 311b is heavier than the key touch feeling of the adjacent two white keys 311w. In view of this, the mass of the mass member 316w3 and the mass of the mass member 316b3 are adjusted for each key as illustrated in FIG. 32. Specifically, as illustrated in a characteristic curve indicating the masses of the mass members 316w3 and 316b3 in the order of pitches, the masses of the mass members 316w3 and 316b3 are adjusted such that the characteristic curve of the mass member 316w3 and the characteristic curve of the mass member 316b3 are parallel downward-sloping curves, wherein the characteristic curve of the mass member 316b3 is located below the characteristic curve of the mass member 316w3. Thus, as illustrated by a chain line in FIG. 33, the key touch feeling on the key depression/release operation positions W30 and B30 becomes gradually lighter toward the high-pitched side from the low-pitched side. Therefore, as illustrated by a broken line in FIG. 33, the key touch feeling on key depression/release operation positions W31 and B31 located posterior to the key depression/release operation positions W30 and B30 by a distance d3 also becomes gradually lighter toward the high-pitched side from the low-pitched side. Since the length of the key to which a higher pitch is assigned is shorter, the difference between the key touch feeling on the key depression/release operation positions W30 and B30 and the key touch feeling on the key depression/release operation positions W31 and B31 becomes larger toward the high-pitched side from the low-pitched side. Specifically, the difference in the key touch feeling caused by the longitudinal difference of the key depression/release operation position is small on the low-pitched side, moderate in the middle-pitched side, and large on the high-pitched side.

When the white key 311w and the black key 311b are released, the front ends of the hammers 316w and 316b displace upward due to their own weight of the hammers 316w and 316b. In this case, the drive portion 311w1 and the drive portion 311b1 are biased upward by the leg portion Fw32 and the leg portion Fb32 respectively, whereby the front ends of the white key 311w and the black key 311b displace upward. On the other hand, when the white key 311w and the black key 311b are depressed, the lower surfaces of the drive portion 311w1 and the drive portion 311b1 press the upper surfaces of the leg portion Fw32 and the leg portion Fb32 respectively, whereby the front ends of the hammer 316w and the hammer 316b respectively displace downward.

A lower-limit stopper 320 is provided to the key frame 312. During the key depression, the lower-limit stopper 320 is brought into contact with the upper surfaces of the mass member 316w3 and the mass member 316b3 of the hammer 316w and the hammer 316b so as to restrict the upward displacement of the back ends of the hammer 316w and the hammer 316b, thereby restricting the downward displacement of the front ends of the white key 311w and the black key 311b. The lower-limit stopper 320 includes a stopper rail 320a and a buffer member 320b. The stopper rail 320a protrudes downward from the lower surface at the middle of the top plate 312a. The stopper rail 320a extends parallel to the lateral direction. The projection amount of the stopper rail 320a from the lower surface of the top plate 312a on the contact portion between the stopper rail 320a and each hammer is constant in the lateral direction. The buffer member 320b is fixed to the lower end surface of the stopper rail 320a. The buffer member 320b is a long member made of a shock-absorbing member such as rubber or felt. The sectional shape of the buffer member 320b is uniform from one end to the other end.

An upper-limit stopper 321 is provided to the middle portion of the frame FR3. During the key release, the upper-limit stopper 321 is brought into contact with the lower surfaces of the mass member 316w1 and the mass member 316b1 of the hammer 316w and the hammer 316b so as to restrict the downward displacement of the back ends of the hammer 316w and the hammer 316b, thereby restricting the upward displacement of the front ends of the white key 311w and the black key 311b. Like the lower-limit stopper 320, the upper-limit stopper 321 includes a stopper rail 321a and a buffer member 321b. Specifically, in a planar view of the key frame 312, the stopper rail 320a extends in parallel in the lateral direction. The projection amount from the frame FR3 is constant in the lateral direction. The buffer member 321b is fixed on the upper surface of the stopper rail 321a. Like the buffer member 320b, the sectional shape of the buffer member 321b is uniform from one end to the other end. The stopper rail 320a and the stopper rail 321a may continuously extend in the lateral direction, or may discontinuously extend. The stopper rail 320a and the stopper rail 321a may be formed integral with the top plate 312a and the frame FR3 respectively, or may be formed as separate components and assembled to the top plate 312a and the frame FR3 respectively.

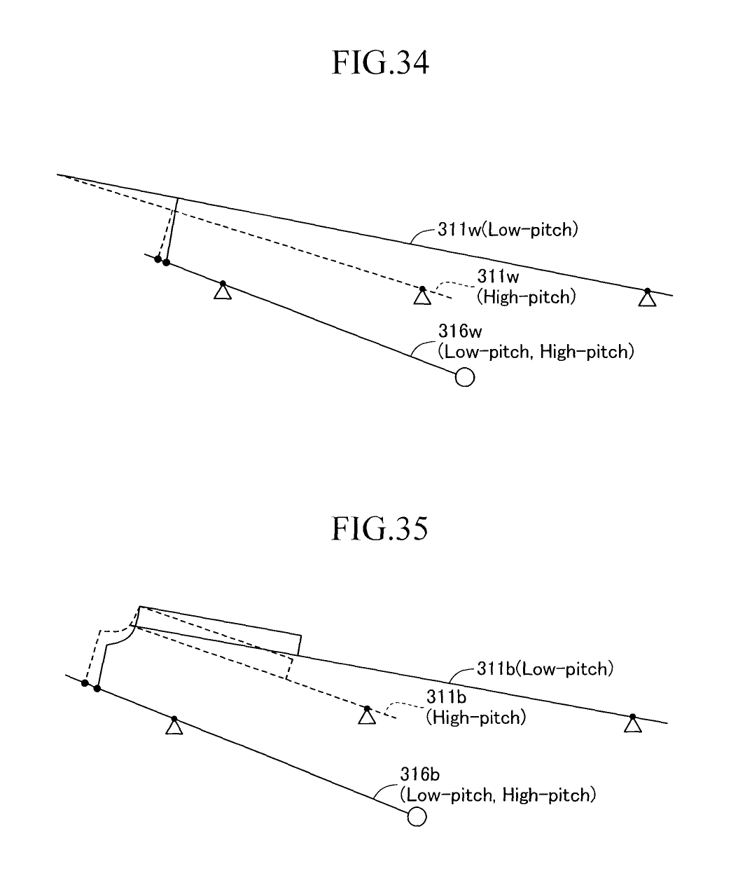

As described above, the white key 311w tilts such that the back end is lower than the front end during the key release. The height of the pivot center of the white key 311w is the same for all white keys 311w. The position of the engagement portions Pw31 of two different white keys 311w in the vertical direction are the same during the key release. Accordingly, if the length of the drive portion 311w1 of the white key 311w in the vertical direction is the same for all white keys 311w, the front end of the white key 311w having the shorter length in the longitudinal direction might become high. In view of this, in the present embodiment, the length of the drive portion 311w1 in the vertical direction is set according to the length of the white key 311w in order to set the height of the front end of each white key 311w in the key release state to be the same. Specifically, the length of the drive portion 311w1 in the vertical direction for the white key 311w having the shorter length in the longitudinal direction is set to be small (see FIG. 34). As described above, in the present embodiment, the size of the white key 311w in the vertical direction is set according to the longitudinal distance from the front end of the white key 311w to the key support portion 313w (the axis of the projection 313w1).

As described above, the black key 311b tilts such that the back end is lower than the front end during the key release. The height of the pivot center of the black key 311b is the same for all black keys 311b. The position of the engagement portions Pb31 of two different black keys 311b in the vertical direction are the same during the key release. Accordingly, if the length of the drive portion 311b1 of the black key 311b in the vertical direction is the same for all black keys 311b, the front end of the black key 311b having the shorter length in the longitudinal direction might become high. In view of this, in the present embodiment, the length of the drive portion 311b1 in the vertical direction is set according to the length of the black key 311b in order to set the height of the front end of each black key 311b in the key release state to be the same. Specifically, the length of the drive portion 311b1 in the vertical direction for the black key 311b having the shorter length in the longitudinal direction is set to be long (see FIG. 35). As described above, in the present embodiment, the size of the black key 311b in the vertical direction is set according to the longitudinal distance from the front end of the black key 311b to the key support portion 313b (the axis of the projection 313b1).

In a state in which two adjacent white keys 311w and the black key 311b between the two adjacent white keys 311w are released, the rocking angle of each hammer is set such that the edge line R3 of the black key 311b is located below the top face of one on the low-pitched side of the two white keys 311w, and above the top face of one on the high-pitched side of the two white keys 311w.

The tilt angle of each key is set such that, in the state in which the white key 311w and the black key 311b adjacent to the white key 311w are depressed respectively by the same depression force, and their rocking movement is restricted, the edge line R3 of the black key 311b is located below the top face of the white key 311w. The buffer member 320b and the buffer member 321b have elasticity. Therefore, when the key is depressed more after the hammer is brought into contact with the buffer member during the key depression, the buffer member is elastically deformed, so that the front end of the key slightly displaces downward.

A switch drive portion AC31 is provided on the lower surface of each of the white key 311w and the black key 311b on the middle part. The switch drive portion AC31 is a plate-like member extending in the vertical direction in each of the white key 311w and the black key 311b, and the lower end surface of the switch drive portion AC31 is brought into contact with the upper surface of a switch SW31. The switch SW31 is provided for each key. The switch SW31 is pressed by the corresponding key to detect whether the corresponding key is depressed or released. Specifically, when the switch SW31 is depressed by the key, a rubber main body is deformed to make two contacts, which are formed on a circuit board 323, short-circuit, thereby being turned ON. The circuit board 323 extends in the lateral direction. Through-holes penetrating from the upper surface to the lower surface are formed on the circuit board 323. The through-holes correspond to a bosses 324 formed integral with the upper surface of the top plate 312a. When screws are threaded to the bosses 324 through the through-hole, the circuit board 323 is fixed to the key frame 312. The main bodies of the plural switches SW31, each corresponding to each key, are arranged on the upper surface of the circuit board 323 in the lateral direction. The position of the switch SW31 for the white key 311w and the position of the switch SW31 for the black key 311b in the longitudinal direction are the same. A distance Lw33 from the front end of the white key 311w to the switch SW31 in the longitudinal direction is within 30% of the distance Lw32 from the front end of the white key 311w with the highest pitch to the through-hole Kw3, and a distance Lb33 from the front end of the apparent portion of the black key 311b to the switch SW31 is within 30% of the distance Lb32 from the front end of the apparent portion of the black key 311b with the highest pitch to the through-hole Kb3. The switch SW31 for the white key 311w and the switch SW31 for the black key 311b may be arranged side by side in the lateral direction, and the positions of both switches in the longitudinal direction may be shifted.

A key guide 325w for guiding the rocking movement of the white key 311w is formed to project upward from the top end surface of the front plate 312d. The key guide 325w is inserted into the white key 311w from below, and during the key depression and key release, the side face of the key guide 325w and the inside face of the sidewall of the white key 311w are in sliding contact with each other. This structure can prevent a slight displacement of the white key 311w in the lateral direction during the key depression and key release.

A key guide 325b for guiding the rocking movement of the black key 311b is formed to project upward from the upper surface of the top plate 312a at the front end. The key guide 325b is inserted into the black key 311b from below, and during the key depression and key release, the side face of the key guide 325b and the inside face of the sidewall of the black key 311b are in sliding contact with each other. This structure can prevent a slight displacement of the black key 311b in the lateral direction during the key depression and key release.

In the keyboard device having the configuration described above, the size of each white key 311w in the vertical direction is set according to the longitudinal distance from the front end of each white key 311w to the key support portion 313w (the axis of the projection 313w1) in order that the height of the front end of each white key 311w during the key release is adjusted to be the same. In addition, the size of each black key 311b in the vertical direction is set according to the longitudinal distance from the front end of each black key 311b to the key support portion 313b (the axis of the projection 313b1) in order that the height of the front end of each black key 311b during the key release is adjusted to be the same. Accordingly, the appearance of the keyboard device can be made similar to the appearance of the keyboard device for an acoustic piano during the key release. In addition, the keyboard device according to the present embodiment has high productivity, because there is no need to adjust the height of the front ends of the keys to be the same by adjusting the number or the thickness of the spacer, which is sandwiched between the key support portion and the frame, as in the keyboard device such as an acoustic piano.

The distance from the top face of the apparent portion of the white key 311w to the pivot center is the same for all white keys 311w, and the distance from the top face of the body of the black key 311b to the pivot center is the same for all black keys 311b. Accordingly, when the through-holes Kw3 and Kb3 are formed in a different process after a process of molding the outer shape of the white key 311w and the black key 311b, the different process can commonly be carried out for all keys to enhance productivity of the keys. The positions of the projections 313w1 and 313b1 of the key support portions 313w and 313b in the vertical direction are set to be the same for all key support portions 313w and 313b, resulting in that the frame 312 that supports the keys is easily designed. In addition, the frame 312 is easily processed, and the precision can be enhanced.

Upon embodying the present invention, the present invention is not limited to the above-described embodiment, and various modifications are possible without departing from the scope of the present invention.

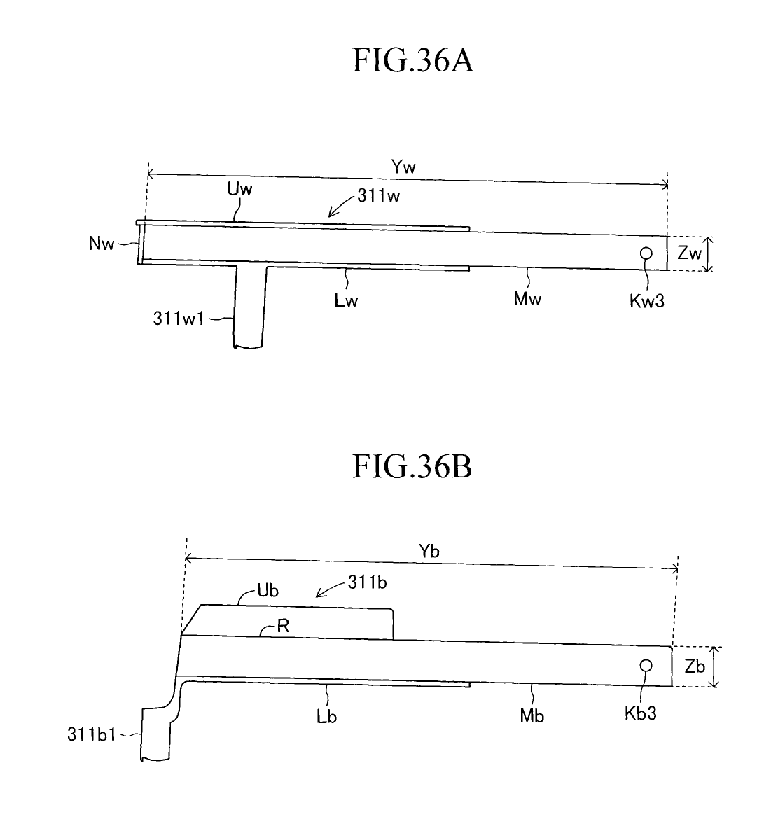

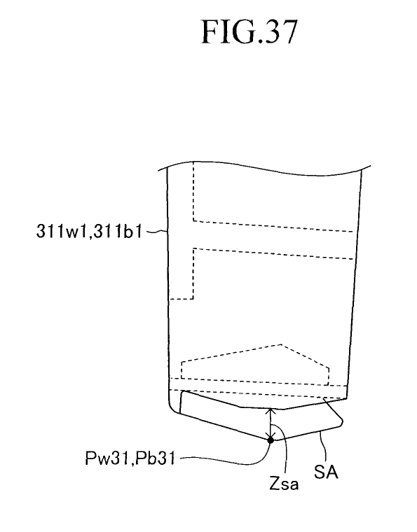

According to the embodiment described above, the length of the drive portion 311w1 in the vertical direction for the white key 311w having the shorter length in the longitudinal direction is set to be short. Instead of this structure, the length of the drive portion 311w1 in the vertical direction may be set to be the same for all white keys 311w, and the length of the body of each white key 311w, in the vertical direction, excluding the drive portion 311w1 may be set such that the height of the front end of the white key 311w in the key release state becomes the same for all white keys 311w. Specifically, the body of the white key 311w in the vertical direction, excluding the drive portion 311w1, for the white key 311w having the shorter length in the longitudinal direction may be set to be short. As illustrated in FIG. 36A, the white key 311w may be formed in such a manner that an upper part Uw, a middle part Mw, and a lower part Lw are combined to be superimposed in the vertical direction, and a front part Nw is assembled to a front end of the middle part Mw. The upper part Uw is formed to have a thin plate-like shape. The middle part Mw is formed to have a prism shape. The lower part Lw is formed to have a thin plate-like shape. The drive portion 311w1 extends downward from the lower surface of the lower part Lw. In this case, the upper part Uw and the lower part Lw may be set to be the same for all white keys 311w, and the size Yw in the longitudinal direction and the size Zw in the vertical direction of the middle part Mw may be set according to the assigned pitch. Specifically, the vertical size Zw of the middle part Mw whose longitudinal size Yw is set to be short is set to be short. Even with this structure, the height of the front end of each white key 311w in the key release state can be adjusted to be the same. Since the upper part Uw and the lower part Lw are made common, cost can be reduced. In the example described above, the size Zw of the middle part Mw is set according to the size Yw. However, instead of this structure, or in addition to this structure, the size of the plate-like portion of the lower part Lw may be set according to the size Yw.

The black key 311b can be configured like the white key 311w. Specifically, the length of the drive portion 311b1 in the vertical direction may be set to be the same for all black keys 311b, and the length of the body of each black key 311b, in the vertical direction, excluding the drive portion 311b1 may be set such that the height of the front end of the black key 311b in the key release state becomes the same for all black keys 311b. Specifically, the body of the black key 311b in the vertical direction, excluding the drive portion 311b1, for the black key 311b having the shorter length in the longitudinal direction may be set to be long. As illustrated in FIG. 36B, the black key 311b may be formed in such a manner that an upper part Ub, a middle part Mb, and a lower part Lb are combined to be superimposed in the vertical direction. The upper part Ub is formed to have a prism shape in which a cross-section perpendicular to the longitudinal direction has a trapezoidal shape. The upper part Ub corresponds to the apparent portion of the black key 311b. The middle part Mb is formed to have a prism shape. The lower part Lb is formed to have a thin plate-like shape. The drive portion 311b1 extends downward from the lower surface of the lower part Lb. In this case, the upper part Ub and the lower part Lb may be set to be the same for all black keys 311b, and the size Yb in the longitudinal direction and the size Zb in the vertical direction of the middle part Mb may be set according to the assigned pitch. Specifically, the vertical size Zb of the middle part Mb whose longitudinal size Yb is set to be short is set to be long. Even with this structure, the height of the front end of each black key 311b in the key release state can be adjusted to be the same. Since the upper part Ub and the lower part Lb are made common, cost can be reduced. In the example described above, the size Zb of the middle part Mb is set according to the size Yb. However, instead of this structure, or in addition to this structure, the size of the plate-like portion of the lower part Lb may be set according to the size Yb.

The total size of the white key 311w in the vertical direction may be set to be the same for all white keys 311w. In this case, a size Zsa of a portion, located below the lower end wall of the drive portion 311w1 and the drive portion 311b1, of the shock absorbing member SA may be set in order that the height of the front end of each white key 311w in the key release state becomes the same for all white keys 311w. Specifically, the size Zsa for the white key 311w having the shorter length in the longitudinal direction may be set to be short. The total size of the black key 311b in the vertical direction may be set to be the same for all black keys 311b. In this case, the size Zsa may be set in order that the height of the front end of each black key 311b in the key release state becomes the same for all black keys 311b. Specifically, the size Zsa for the black key 311b having the shorter length in the longitudinal direction may be set to be long. Even with this structure, the effect same as the embodiment described above can be obtained.

In the embodiment described above, the white key 311w and the black key 311b are supported by the key support portions 313w and 313b of the key frame 312 by fitting the projections 313w1 and 313b1 to the through-holes Kw3 and Kb3 respectively so that the front ends of the white key 311w and the black key 311b can rock in the vertical direction. However, the white key 311w and the black key 311b can be mounted on the key frame 312 by using various supporting mechanisms, if the white key 311w and the black key 311b are supported by the key frame 312 so that the front ends of the white key 311w and the black key 311b can rock in vertical direction. For example, the rear ends of plural keys (the white key 311w and/or the black key 311b) may be are supported by the key frame 312 through elastic deformation members so that the front ends of the plural keys can rock in vertical direction. Concretely, the rear ends of the plural keys are connected to a fixing member fixed to the key frame 312 through thin and elastic connection members, wherein the fixing member is extended in the lateral direction, the connection members are extended horizontally or vertically, and the plural keys, the connection members and the fixing member are formed integrally. In this case, for example, the connection members for the white keys 311w are extended horizontally, and the connection members for the black keys 311b are extended vertically.

What is claimed is:

1. A keyboard device for an electronic musical instrument, the keyboard device comprising:
plural white keys and black keys that are supported by a key support portion in order that front ends thereof rock in a vertical direction by a key depression/release operation by a performer, each white key having an edge line extending in a longitudinal direction on a crossing portion of a side face and a top face, and each black key having an edge line extending in the longitudinal direction on a crossing portion of a lower side face and an upper side face tilting inward with respect to the lower side face, wherein each of plural white keys and each of black keys include an operation portion that is depressed and released by the performer, and a drive portion extending downward, and a length from the front end of the operation portion to the key support portion is different among the plural white keys and black keys;
plural hammers, each of which is engaged with the drive portion of each of the plural white keys and the drive portion of each of the plural black keys, and each of which is supported by a hammer support portion in order to rock with the rocking movement of each of the plural white keys and black keys; and
a restricting member that restricts the rocking movement of the plural hammers in order to restrict the rocking range of the plural white keys and the plural black keys, wherein,
a vertical length of the drive portion of a first key and a vertical length of the drive portion of a second key are set to be the same, the first key and the second key being both the white keys or both the black keys out of the plural white keys and the plural black keys, and
the vertical position of the hammer support portion of the first hammer engaged with the first key and the vertical position of the hammer support portion of the second hammer engaged with the second key are respectively set to a position according to the distance from the front end of the operation portion of the first key to the key support portion and the distance from the front end of the operation portion of the second key to the key support portion, in order that the vertical positions of the front ends of the operation portions of the first key and the second key become the same in a state in which the first key and the second key are released.

2. The keyboard device according to claim 1, wherein
the drive portion of the first key and the drive portion of the second key are respectively provided posterior to the front end of the operation portion of the first key and the front end of the operation of the second key,
the distance from the front end of the operation portion of the first key to the key support portion is longer than the distance from the front end of the operation portion of the second key to the key support portion, and
the hammer support portion of the first hammer is located to be higher than the hammer support portion of the second hammer.

3. The keyboard device according to claim 1, wherein
the drive portion of the first key and the drive portion of the second key are respectively provided anterior to the front end of the operation portion of the first key and the front end of the operation of the second key,
the distance from the front end of the operation portion of the first key to the key support portion is longer than the distance from the front end of the operation portion of the second key to the key support portion, and
the hammer support portion of the first hammer is located to be lower than the hammer support portion of the second hammer.

4. The keyboard device according to claim 1, wherein
the length from the front end of the operation portion to the back end of the plural white keys becomes shorter toward the high-pitched side from the low-pitched side, and the length from the front end of the operation portion to the back end of the plural black keys becomes shorter toward the high-pitched side from the low-pitched side.

5. The keyboard device according to claim 1, wherein
the distance between a plane including the edge line of the first key and the key support portion of the first key is set to be the same as the distance between a plane including the edge line of the second key and the key support portion of the second key.

6. The keyboard device according to claim 1, wherein
the vertical positions of the key support portions of the first key and the second key are set to be the same.

7. The keyboard device according to claim 1, wherein
the first key and the second key are adjacent white keys, and the edge line of the black key between the first key and the second key is located between the top face of the first key and the top face of the second key, in a state in which the first key, the second key, and the black key are released.

8. The keyboard device according to claim 1, wherein
the first key and the second key are adjacent white keys, and the edge line of the black key between the first key and the second key is located below the top face of the first key and the top face of the second key, in a state in which the first key, the second key, and the black key are depressed, and the rocking movements of the first key, the second key, and the black key are restricted.

9. A keyboard device for an electronic musical instrument, the keyboard device comprising:
plural white keys and black keys that are supported by a key support portion in order that front ends thereof rock in a vertical direction by a key depression/release operation by a performer, each white key having an edge line extending in a longitudinal direction on a crossing portion of a side face and a top face, and each black key having an edge line extending in the longitudinal direction on a crossing portion of a lower side face and an upper side face tilting inward with respect to the lower side face, wherein each of plural white keys and each of black keys include an operation portion that is depressed and released by the performer, and a drive portion extending downward, and a length from the front end of the operation portion to the key support portion is different among the plural white keys and black keys;
plural hammers, each of which includes an engagement portion engaged with the drive portion of each of the plural white keys and the drive portion of each of the plural black keys, and each of which is supported by a hammer support portion in order to rock with the rocking movement of each of the plural white keys and black keys; and
a restricting member that restricts the rocking movement of the plural hammers in order to restrict the rocking range of the plural white keys and the plural black keys, wherein,
a vertical length of the drive portion of a first key and a vertical length of the drive portion of a second key are set to be the same, the first key and the second key being both the white keys or being both the black keys out of the plural white keys and the plural black keys,
the longitudinal position and the vertical position of the hammer support portion of the first hammer engaged with the first key and the longitudinal position and the vertical position of the hammer support portion of the second hammer engaged with the second key are set to be the same, and
a vertical position of an engagement point of the first key and the first hammer and a vertical position of an engagement point of the second key and the second hammer are respectively set to a position according to the distance from the front end of the operation portion of the first key to the key support portion and the distance from the front end of the operation portion of the second key to the key support portion, in order that the vertical positions of the front ends of the operation portions of the first key and the second key become the same in a state in which the first key and the second key are released.

10. The keyboard device according to claim 9, wherein
the restricting member includes an upper-limit stopper restricting an upward rocking movement of the front ends of the first key and the second key, and
a position of a contact point between the first hammer and the upper-limit stopper and a position of a contact point between the second hammer and the upper-limit stopper are respectively set to a position according to the distance from the front end of the operation portion of the first key to the key support portion and the distance from the front end of the operation portion of the second key to the key support portion, in order that a rocking angle of the first hammer and a rocking angle of the second hammer in the key release state of the first key and the second key are respectively set to an angle according to the distance from the front end of the operation portion of the first key to the key support portion and the distance from the front end of the operation portion of the second key to the key support portion.

11. The keyboard device according to claim 10, wherein
the first hammer and the second hammer respectively include a contact portion to the upper-limit stopper,
the contact portion has a contact surface extending in the longitudinal direction,
the contact surface tilts with respect to the mounting surface of the upper-limit stopper in the key release state of the first key and the second key, and
the longitudinal position of the upper-limit stopper with respect to the contact portion of the first hammer and the longitudinal position of the upper-limit stopper with respect to the contact portion of the second hammer are respectively set to a position according to the distance from the front end of the operation portion of the first key to the key support portion and the distance from the front end of the operation portion of the second key to the key support portion, in order that the vertical position of the contact point between the first hammer and the upper-limit stopper and the vertical position of the contact point between the second hammer and the upper-limit stopper are set to be the same, and that the longitudinal position of the contact point between the first hammer and the upper-limit stopper and the longitudinal position of the contact point between the second hammer and the upper-limit stopper are respectively set to a position according to the distance from the front end of the operation portion of the first key to the key support portion and the distance from the front end of the operation portion of the second key to the key support portion.

12. The keyboard device according to claim 11, wherein
the drive portion of each of the plural white keys is provided posterior to the front end of the operation portion of each of the plural white keys,
the drive portion of each of the plural black keys is provided anterior to the front end of the operation portion of each of the plural black keys, and
a tilting direction of the contact surface of the hammer engaged with the white key and a tilting direction of the contact surface of the hammer engaged with the black key are reverse to each other.

13. The keyboard device according to claim 10, wherein
the thickness of the upper-limit stopper that is in contact with the first hammer and the second hammer is set to be a thickness according to the distance from the front end of the operation portion of the first key to the key support portion and the distance from the front end of the operation portion of the second key to the key support portion, in order that the vertical position of the contact point between the first hammer and the upper-limit stopper and the vertical position of the contact point between the second hammer and the upper-limit stopper are respectively set to a position according to the distance from the front end of the operation portion of the first key to the key support portion and the distance from the front end of the operation portion of the second key to the key support portion.

14. The keyboard device according to claim 9, wherein
the engagement portion of the first hammer and the engagement portion of the second hammer respectively have a base member and a spacer mounted to the base member, and
the thickness of the spacer is set according to the distance from the front end of the operation portion of the first key to the key support portion and the distance from the front end of the operation portion of the second key to the key support portion.

15. The keyboard device according to claim 9, wherein
the first hammer and the second hammer are bent in the vertical direction on the middle part in the longitudinal direction by a bending process, and
a bending amount of the first hammer and the second hammer by the bending process is set according to the distance from the front end of the operation portion of the first key to the key support portion and the distance from the front end of the operation portion of the second key to the key support portion.

16. The keyboard device according to claim 9, wherein
the length from the front end of the operation portion to the back end of the plural white keys becomes shorter toward the high-pitched side from the low-pitched side, and the length from the front end of the operation portion to the back end of the plural black keys becomes shorter toward the high-pitched side from the low-pitched side.

17. The keyboard device according to claim 9, wherein
the distance between a plane including the edge line of the first key and the key support portion of the first key is set to be the same as the distance between a plane including the edge line of the second key and the key support portion of the second key.

18. The keyboard device according to claim 9, wherein
the positions of the key support portions of the first key and the second key are set to be the same.

19. The keyboard device according to claim 9, wherein
the first key and the second key are adjacent white keys, and the edge line of the black key between the first key and the second key is located between the top face of the first key and the top face of the second key, in a state in which the first key, the second key, and the black key are released.

20. The keyboard device according to claim 9, wherein
the first key and the second key are adjacent white keys, and the edge line of the black key between the first key and the second key is located below the top face of the first key and the top face of the second key, in a state in which the first key, the second key, and the black key are depressed, and the rocking movements of the first key, the second key, and the black key are restricted.

21. A keyboard device for an electronic musical instrument, the keyboard device comprising:
plural white keys and black keys that are supported by a key support portion in order that front ends thereof rock in a vertical direction by a key depression/release operation by a performer, each white key having an edge line extending in a longitudinal direction on a crossing portion of a side face and a top face, and each black key having an edge line extending in the longitudinal direction on a crossing portion of a lower side face and an upper side face tilting inward with respect to the lower side face, wherein each of plural white keys and each of black keys include an operation portion that is depressed and released by the performer, and a drive portion extending downward, and a length from the front end of the operation portion to the key support portion is different among the plural white keys and black keys;
plural hammers, each of which is engaged with the drive portion of each of the plural white keys and the drive portion of each of the plural black keys, and each of which is supported by a hammer support portion in order to rock with the rocking movement of each of the plural white keys and black keys; and
a restricting member that restricts the rocking movement of the plural hammers in order to restrict the rocking range of the plural white keys and the plural black keys, wherein,
vertical positions of engagement portions between the plural white keys as well as the plural black keys and the plural hammers are set to be the same in a state in which the plural white keys and the plural black keys are released, and
in a state in which a first key and a second key out of the plural white keys and the plural black keys are released, the first key and the second key being both the white keys or being both the black keys, the vertical size of the first key and the vertical size of the second key are respectively set according to the distance from the front end of the operation portion of the first key to the key support portion and the distance from the front end of the operation portion of the second key to the key support portion in order that the vertical positions of the front ends of the operation portions of the first key and the second key become the same.

22. The keyboard device according to claim 21, wherein
the first key and the second key are configured by combining plural components in the vertical direction, and
the vertical size of one or more components out of the plural components forming the first key and the second key is set according to the distance from the front end of the operation portion of the first key to the key support portion and the distance from the front end of the operation portion of the second key to the key support portion.

23. The keyboard device according to claim 22, wherein
the plural components forming the first key and the second key include a shock absorbing member mounted on a lower end of the drive portion, and the thickness of the shock absorbing member is set according to the distance from the front end of the operation portion of the first key to the key support portion and the distance from the front end of the operation portion of the second key to the key support portion.

24. The keyboard device according to claim 21, wherein
the length from the front end of the operation portion to the back end of the plural white keys becomes shorter toward the high-pitched side from the low-pitched side, and the length from the front end of the operation portion to the back end of the plural black keys becomes shorter toward the high-pitched side from the low-pitched side.

25. The keyboard device according to claim 21, wherein
the distance between a plane including the edge line of the first key and the key support portion of the first key is set to be the same as the distance between a plane including the edge line of the second key and the key support portion of the second key.

26. The keyboard device according to claim 21, wherein
the positions of the key support portions of the first key and the second key are set to be the same.

27. The keyboard device according to claim 21, wherein
the first key and the second key are adjacent white keys, and the edge line of the black key between the first key and the second key is located between the top face of the first key and the top face of the second key, in a state in which the first key, the second key, and the black key are released.

28. The keyboard device according to claim 21, wherein
the first key and the second key are adjacent white keys, and the edge line of the black key between the first key and the second key is located below the top face of the first key and the top face of the second key, in a state in which the first key, the second key, and the black key are depressed, and the rocking movements of the first key, the second key, and the black key are restricted.
